(19) United States
(12) Patent Application Publication
(10) Pub. No.: US 2025/0323441 A1
(43) Pub. Date: Oct. 16, 2025

(54) CONNECTOR DEVICE AND MANUFACTURING METHOD OF THE SAME

(71) Applicant: HIROSE ELECTRIC CO., LTD., Kanagawa (JP)

(72) Inventor: Masahiro Tanaka, Kanagawa (JP)

(21) Appl. No.: 19/172,856

(22) Filed: Apr. 8, 2025

(30) Foreign Application Priority Data
Apr. 10, 2024 (JP) 2024-063439
Feb. 10, 2025 (JP) 2025-020216

(51) Int. Cl. H01R 12/77; H01R 13/506; H01R 43/24

(52) U.S. Cl. CPC H01R 12/771; H01R 13/506; H01R 43/24

(57) ABSTRACT

A connector device includes a connector part, cables extending from the back end portion of the connector part, and a back housing, wherein a cross-sectional shape of the cover portion of each cable is quadrilateral, the front end portions of the cables are arranged in parallel such that there is no space formed by separating the respective cover portions of the two adjacent cables in the cables from each other in a cross section of a whole of the cables, and the back housing surrounds a portion from the back end portion of the connector part to the front end portions of the respective cover portions of the cables and is integrated with the portion by overmolding.

### INCORPORATION BY REFERENCE

This application is based on and claims the benefit of priority from Japanese patent applications No. 2024-063439 filed on Apr. 10, 2024 and No. 2025-020216 filed on Feb. 10, 2025, which is incorporated by reference in its entirety.

### BACKGROUND

The present invention relates to a connector device provided with a plurality of cables and a connection part for connecting the plurality of cables to a connecting object, and a method of manufacturing the connector device.

A connector device provided with a plurality of cables and a connection part for connecting the plurality of cables to a connecting object is known. The connection part is a connector, a terminal, or a member functioning as the connector or the terminal. The connecting object is a connector which can be connected to the connection part, a terminal which can be connected to the connection part, or a member that functions as such the connector or the terminal. The plurality of cables are independent of each other. Each of the ends of the plurality of cables is attached to the identical one connection part.

Each cable has a core portion and a cover portion covering the outer circumference of the core portion. A configuration of the core portion differs depending on the type of cable. For example, in a case of a single-core cable, the core portion is a single conductive wire (a single wire or a twisted wire). In a case of a multi-core cable, the core portion is a plurality of conductive wires each of whose outer circumference is covered with an insulator. In a case of a coaxial cable, the core portion is a conductive wire, an insulator covering the outer circumference of the conductive wire, and a shielded conductor (for example, a braid) covering the outer circumference of the insulator. In a case of a multi-core shielded cable, the core portion is a plurality of conductive wires each of whose outer circumference is covered with an insulator, and a shield conductor covering the outer circumference of the conductive wires.

JP2009-110880 (Patent Document 1) discloses a cable connection device including a plurality of cables and a plug for holding the plurality of cables. The cable connection device is considered to be structurally equivalent to the connector device described above.

According to the above-described connector device, since the ends of the plurality of cables are respectively attached to the same connection part, by connecting the connection part to the connecting object or disconnecting the connection part from the connecting object, an electrical connection or disconnection between the plurality of cables and a substrate or an electrical/electronic device to which the connecting object is attached can be performed at once. In the above-described connector device, although the ends of the plurality of cables are attached to one connection part, the portions other than the ends are independent and separable. Therefore, the wiring paths of the plurality of cables can be made different from each other. By using the connector device described above, for example, a system for transmitting signals from a plurality of electrical/electronic devices arranged at different locations to single another electrical/electronic device can be easily constructed.

### PRIOR ART DOCUMENTS

### Patent Documents

[Patent Document 1] JP2009-110880

### OUTLINE OF THE INVENTION

### Problems to be Solved by the Invention

In the above-described connector device, it is required to enhance strength to hold the cables and to enhance liquid-stopping performance, which is performance of preventing liquid (for example, water) from entering the connector device. In response to such a request, it has been studied to form a resin housing which collectively covers the connection part and the ends of the plurality of cables attached to the connection part by overmolding.

A connector device 91 in FIG. 28 is the connector device having such a housing. That is, the connector device 91 includes a connection part 92 and four cables 93 to 96. Each of the cables 93 to 96 is a well known single-core cable that is widely used and has a circular cross-sectional shape. Each of the cables 93 to 96 has a core portion 97 and a cover portion 98. The one ends of the core portions 97 of the cables 93 to 96 are attached to the base end of the connection part 92. A resin housing 99 is formed on the outer circumference of a portion from the base end of the connection part 92 to the one ends of the cover portions 98 of the cables 93 to 96 to cover the portion. Hereinafter, the connector device 91 may be referred to as “a connector device as a comparative example”.

FIGS. 29A and 29B show an example of a method of manufacturing the connector device 91. In manufacturing the connector device 91, first, as shown in FIG. 29A, the one ends of the core portions 97 of the cables 93 to 96 are attached to the base end of the connection part 92. Then, the cables 93 to 96 are arranged in parallel so as to form two rows in the upper-and-lower direction and two rows in the left-and-right direction. Next, in order to mold the housing 99 indicated by the two-dot chain line in FIG. 29B, the connection part 92, the one ends of the core portions 97 and the cover portion 98 of the cables 93 to 96 are arranged in the mold, and the molten resin is injected into the mold.

However, the connector device 91 shown in FIG. 28 or the method of manufacturing the connector device 91 shown in FIGS. 29A and 29B have a problem that a molding failure of the housing 99 is likely to occur. This problem will be described in detail with reference to FIGS. 30A and 30B.

FIG. 30A schematically shows a state in which the connection part 92 to which the cables 93 to 96 are attached and the one ends of the cables 93 to 96 are arranged in the mold 120 in order to form the housing 99. The broken line in FIG. 30A indicates a portion of the connection part 92 and the cables 93 to 96 located in the mold 120. In FIG. 30A, the two-dot chain line indicates a cavity 125 formed in the mold 120. A resin is injected into the cavity 125.

The mold 120 has a first mold piece 121 and a second mold piece 122. For example, the second mold piece 122 can move upward and downward with respect to the first mold piece 121. The connection part 92 and the one ends of the cables 93 to 96 are arranged between the first mold piece 121 and the second mold piece 122 so as to be positioned in the mold 120. On the other hand, the portions of the cables 93 to 96 other than the one ends are exposed from the mold 120. The mold 120 is provided with a cable insertion part 120A for route the portions of the cables 93 to 96 other than the one ends out of the mold 120.

FIG. 30B shows a cross section of the cable insertion part 120A of the mold 120 and the cables 93 to 96 passing the cable insertion part 120A taken along the line T-T in FIG. 30A, as viewed from the left side in FIG. 30A. As shown in FIG. 30B, in the cable insertion part 120A, recesses 121A and 122A are respectively formed in the first mold piece 121 and the second mold piece 122, and the lower portions of the cables 95 and 96 are arranged in the recesses 121A, and the upper portions of the cables 93 and 94 are arranged in the recesses 122A. In the cable insertion part 120A, a gap is formed between the left portion of the first mold piece 121 and the left portion of the second mold piece 122, and a third mold piece 123 (insert) is inserted in the gap from the left side. In the cable insertion part 120A, a gap is also formed between the right portion of the first mold piece 121 and the right portion of the second mold piece 122, and a fourth mold piece 124 (insert) is inserted in the gap from the right side.

The recess 121A of the first mold piece 121 has a shape corresponding to the shape of the lower portions of the respective cover portions 98 of the cables 95 and 96. Therefore, no space is formed between the recess 121A and the lower portions of the respective cover portions 98 of the cables 95 and 96. The recess 122A of the second mold piece 122 has a shape corresponding to the shape of the upper portions of the respective cover portions 98 of the cables 93 and 94. Therefore, no space is formed between the recess 122A and the upper portions of the respective cover portions 98 of the cables 93 and 94. The right end portion of the third mold piece 123 has a shape corresponding to the shape of the left portions of the respective cover portions 98 of the cables 94 and 95. Therefore, no space is formed between the right end portion of the third mold piece 123 and the left portions of the respective cover portions 98 of the cables 94 and 95. The left end portion of the fourth mold piece 124 has a shape corresponding to the shape of the right portions of the respective cover portions 98 of the cables 96 and 93. Therefore, no space is formed between the left end portion of the fourth mold piece 124 and the right portions of the respective cover portions 98 of the cables 96 and 93. However, in the cable insertion part 120A, a space 126 is formed in a portion surrounded by the four cables 93 to 96. The space 126 is a space formed in the cross section of all the cables 93 to 96 when the four cables 93 to 96 each having a circular cross-sectional shape are arranged in two rows in the upper-and-lower direction and in two rows in the left-and-right direction as shown in FIG. 30B.

That is, when the four cables 93 to 96 each having a circular cross-sectional shape are arranged in two rows in the upper-and-lower direction and in two rows in the left-and-right direction as shown in FIG. 30B, the left lower portion of the outer circumferential surface of the cover portion 98 of the cable 93 arranged at the right upper and the right lower portion of the outer circumferential surface of the cover portion 98 of the cable 94 arranged at the left upper are separated from each other. The right lower portion of the outer circumferential surface of the cover portion 98 of the cable 94 and the right upper portion of the outer circumferential surface of the cover portion 98 of the cable 95 arranged at the left lower are separated from each other. The right upper portion of the outer circumferential surface of the cover portion 98 of the cable 95 and the left upper portion of the outer circumferential surface of the cover portion 98 of the cable 96 arranged at the right lower are separated from each other. The left upper portion of the outer circumferential surface of the cover portion 98 of the cable 96 and the left lower portion of the outer circumferential surface of the cover portion 98 of the cable 93 are separated from each other. As a result, the space 126 is formed in the cross section of all the cables 93 to 96. The space 126 is a space surrounded by the four cables 93 to 96 such that the mold cannot enter.

When molten resin is injected into the mold 120 to form the housing 99, the resin flows out of the mold 120 through the space 126. Therefore, when the resin is injected, a pressure of the resin in the mold 120 is not sufficiently increased, and as a result, molding failure such as short molding is likely to occur. Further, since the resin flows between the cables 93 to 96 through the space 126, it is necessary to perform a complicated operation to remove the resin.

FIG. 31A shows a cross section of five cables attached to a plug in a cable connecting apparatus described in JP2009-110880. As shown in FIG. 31A or FIG. 2B of the above-described publication, the cross-sectional shape of each of the five cables is circular. The five cables are arranged in two rows in the upper-and-lower direction, in which the upper row contains the two cables arranged in the left-and-right direction and the lower row contains three cables arranged in the left-and-right direction. A space 127 in which the mold cannot enter is also formed in the cross section of all the five cables. Therefore, in the connector device 91, even when the five cables shown in FIG. 31A are attached to the connection part 92 in place of the cables 93 to 96, the molding failure is likely to occur when the housing 99 is formed.

Also, as shown in FIG. 31B, even when the three cables each having a circular cross-sectional shape are arranged in such a way that they are arranged in two rows in the upper-and-lower direction, in which the upper row contains one cable and the lower row contains two cables arranged in the left-and-right direction, a space 128 in which the mold cannot enter is formed in the cross section of all the three cables. Therefore, in the connector device 91, even when the three cables shown in FIG. 31B are attached to the connection part 92 in place of the cables 93 to 96, the molding failure is likely to occur when the housing 99 is formed.

Also, as shown in FIG. 31C, even when the two parallel two-wire cables are arranged in two rows in the upper-and-lower direction, a space 129 in which the mold cannot enter is formed in the cross section of all the two parallel two-wire cables. Therefore, in the connector device 91, even when the two parallel two-wire cables shown in FIG. 31C are attached to the connection part 92 in place of the cables 93 to 96, the molding failure is likely to occur when the housing 99 is formed.

As described above, in the above-described connector device, when three or more cables each having a circular cross-sectional shape are attached to the connection part, and the cables are arranged so as to be aligned in the upper-and-lower direction and in the left-and-right direction, and as a result, a space is formed in the cross section of all the cables by at least partially separating the respective cover portions of the two adjacent cables from each other, the resin flows out of the mold through the space when the housing is molded, and the molding failure of the housing is likely to occur. Further, such a molding failure may also occur when two parallel two-wire cables are attached to the connection part and the parallel two-wire cables are arranged, for example, as shown in FIG. 31C. If such a molding failure occurs, in the connector device, it becomes difficult to enhance strength to hold the cables or to enhance the liquid stopping performance by forming the housing which collectively covers the connection part and the ends of the plurality of cables by overmolding.

On the other hand, even if the cross-sectional shape of each of the plurality of cables attached to the connection part is circular, by arranging the cables in a horizontal row as shown in FIG. 32A, for example, it is possible to prevent the formation of the space allowing the outflow of resin in the cross section of all the cables when the housing is molded. However, when a plurality of cables are arranged in a horizontal row, a width of the connector device is increased, and the connector device is enlarged. It is not desirable to increase the size of the connector device.

Further, as shown in FIG. 32B, when a plurality of cables are arranged so as to be separated from each other, it is necessary to equip the connector device or the mold with a mechanism for closing the space between the cables in order to prevent the outflow of the resin during the housing molding and a mechanism for supporting each cable in order to prevent displacement of the cables due to pressure of the resin during the housing molding. Therefore, the structure of the connector device or the mold becomes complicated, and the manufacturing process of the connector device becomes complicated, and as a result, the manufacturing cost of the connector device increases.

An object of the present invention is to provide a connector device and a method of manufacturing the connector device which can enhance strength to hold cables or liquid stopping performance by molding a housing covering a connection part and one ends of the cables, and can suppress the molding failure of the housing.

### SUMMARY

In order to solve the above problems, a connector device of the present invention is a connector device including a connection part whose one end portion is connected to a connecting object, a plurality of cables extending from the other end portion of the connection part, and a housing, wherein each of the plurality of cables has a core portion and a cover portion covering an outer circumference of the core portion, a flat portion is formed on an outer circumferential surface of the cover portion of each of the plurality of cables, one end portions of the plurality of cables are arranged in parallel such that the flat portions of the respective cover portions of the two adjacent cables in the plurality of cables are in contact with each other, and there is no space formed by separating the respective cover portions of the two adjacent cables in the plurality of cables within a cross section of a whole of the plurality of cables, and the housing surrounds a portion from the other end portion of the connection part to one end portions of the respective cover portions of the plurality of cables, and is integrated with the portion by overmolding.

In the above connector device of the present invention, the housing surrounds the portion from the other end portion of the connection part to one end portions of the respective cover portions of the plurality of cables, and is integrated with the portion by overmolding. Therefore, the strength to hold the cables can be enhanced, and the liquid stopping performance of the connector device can be enhanced. In the above connector device of the present invention, the flat portion is formed on the outer circumferential surfaces of the respective cover portions of the plurality of cables. One end portions of the plurality of cables are arranged such that the flat portions of the respective cover portions of the two adjacent cables are in contact with each other. By arranging one end portions of the plurality of cables in this manner, it is possible to prevent a space formed by wholly or partially separating the cover portions of the two adjacent cables from each other from being formed in the cross section of the whole of the plurality of cables. When the housing is formed, a portion from the other end portion of the connection part to one end portions of the respective cover portions of the plurality of cables is arranged in the mold for molding the housing, and a molten material for molding the housing is injected into the mold. At this time, since the above-mentioned space does not exist in the cross section of the whole of one end portions of the plurality of cables, it is possible to suppress the material injected into the mold from flowing out of the mold. Therefore, the pressure of the material in the mold can be sufficiently increased. Therefore, when the housing is molded, a molding failure such as a short mold hardly occurs.

In the above connector device of the present invention, exposed portions exposed from the cover portions may be formed at one end portions of the respective core portions of the plurality of cables, the other end portions of the exposed portions of the respective core portions of the plurality of cables may be exposed from the other end portion of the connection part to an outside of the connection part, and the housing may surround the other end portion of the connection part, the other end portions of the exposed portions of the respective core portions of the plurality of cables, and one end portions of the respective cover portions of the plurality of cables, and may be integrated with the other end portion of the connection part, the other end portions of the exposed portions of the respective core portions of the plurality of cables, and one end portions of the respective cover portions of the plurality of cables by overmolding.

In the above connector device of the present invention, the plurality of cables may include four or more cables, when an extension direction of the plurality of cables is defined as a front-and-back direction, the plurality of cables may be arranged in two or more rows in an upper-and-lower direction and in two or more rows in a left-and-right direction. In the above connector device of the present invention, the plurality of cables may include a first cable, a second cable, a third cable, and a fourth cable, when an extension direction of the first cable is defined as a front-and-back direction, a flat portion may be formed on a left portion and a lower portion of the outer circumferential surface of the cover portion of the first cable, respectively, when an extension direction of the second cable is defined as the front-and-back direction, a flat portion may be formed on a right portion and a lower portion of the outer circumferential surface of the cover portion of the second cable, respectively, when an extension direction of the third cable is defined as the front-and-back direction, a flat portion may be formed on a right portion and an upper portion of the outer circumferential surface of the cover portion of the third cable, respectively, when an extension direction of the fourth cable is defined as the front-and-back direction, a flat portion may formed on a left portion and an upper portion of the outer circumferential surface of the cover portion of the fourth cable, respectively, and the first cable, the second cable, the third cable, and the fourth cable may be arranged such that the flat portion of the left portion of the cover portion of the first cable and the flat portion of the right portion of the cover portion of the second cable are in contact with each other, the flat portion of the lower portion of the cover portion of the second cable and the flat portion of the upper portion of the cover portion of the third cable are in contact with each other, the flat portion of the right portion of the cover portion of the third cable and the flat portion of the left portion of the cover portion of the fourth cable are in contact with each other, and the flat portion of the upper portion of the cover portion of the fourth cable and the flat portion of the lower portion of the cover portion of the first cable are in contact with each other. In the above connector device of the present invention, the plurality of cables may include a first cable, a second cable, a third cable, and a fourth cable, an outer profile of a cross section of the cover portion of each of the first cable, the second cable, the third cable and the fourth cable may be quadrilateral, when an extension direction of each of the first cable, the second cable, the third cable, and the fourth cable is defined as a front-and-back direction, the first cable, the second cable, the third cable, and the fourth cable may be arranged such that a left surface of the cover portion of the first cable and the a right surface of the cover portion of the second cable are in contact with each other, a lower surface of the cover portion of the second cable and an upper surface of the cover portion of the third cable are in contact with each other, a right surface of the cover portion of the third cable and a left surface of the cover portion of the fourth cable are in contact with each other, and an upper surface of the cover portion of the fourth cable and a lower surface of the cover portion of the first cable are in contact with each other. In the above connector device of the present invention, an outer profile of a cross section of the cover portion of each of the plurality of cables may be a quadrilateral having four internal angles of 90 degrees. In this case, one end portions of the plurality of cables may be arranged such that an outer profile of a cross section of a whole of the plurality of cables is a quadrilateral having four internal angles of 90 degrees.

In the above connector device of the present invention, the plurality of cables may extend backwardly from a back end portion of the connection part, and the housing may be a resin molded product which surrounds a portion from the back end portion of the connection part to front end portions of the respective cover portions of the plurality of cables and may be integrated with the portion by overmolding, back portions of portions surrounded by the housing in the plurality of cables may be arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and front portions of the portions surrounded by the housing in the plurality of cables may be arranged in parallel so as to form a spaced portion where the respective cover portions of the two adjacent cables in the plurality of cables are separated from each other. In the connector device, the resin for forming the housing enters the spaced portion and the resin is in close contact with the cover portion of the cable, thereby enhancing the liquid stopping performance and the cable holding strength of the connector device.

In the above connector device of the present invention, the plurality of cables may include four or more cables, the plurality of cables may be arranged in two or more rows in an upper-and-lower direction and in two or more rows in a left-and-right direction, the back portions of the portions surrounded by the housing in the plurality of cables may be arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and the front portions of the portions surrounded by the housing in the plurality of cables may be arranged so as to form a spaced portion where the respective cover portions of the two cables adjacent to each other in the upper-and-lower direction in the plurality of cables are separated from each other, or to form a spaced portion where the respective cover portions of the two cables adjacent to each other in the left-and-right direction in the plurality of cables are separated from each other. In the above connector device of the present invention, the plurality of cables may include a first cable, a second cable, a third cable, and a fourth cable, a flat portion may be formed on a left portion and a lower portion of the outer circumferential surface of the cover portion of the first cable, respectively, a flat portion may be formed on a right portion and a lower portion of the outer circumferential surface of the cover portion of the second cable, respectively, a flat portion may be formed on a right portion and an upper portion of the outer circumferential surface of the cover portion of the third cable, respectively, a flat portion may be formed on a left portion and an upper portion of the outer circumferential surface of the cover portion of the fourth cable, respectively, wherein the back portions of the portions surrounded by the housing in the first cable, the second cable, the third cable, and the fourth cable may be arranged such that the flat portion of the left portion of the cover portion of the first cable and the flat portion of the right portion of the cover portion of the second cable are in contact with each other, the flat portion of the lower portion of the cover portion of the second cable and the flat portion of the upper portion of the cover portion of the third cable are in contact with each other, the flat portion of the right portion of the cover portion of the third cable and the flat portion of the left portion of the cover portion of the fourth cable are in contact with each other, and the flat portion of the upper portion of the cover portion of the fourth cable and the flat portion of the lower portion of the cover portion of the first cable are in contact with each other, and the front portions of the portions surrounded by the housing in the first cable, the second cable, the third cable, and the fourth cable may be arranged such that the flat portion of the left portion of the cover portion of the first cable and the flat portion of the right portion of the cover portion of the second cable are separated from each other, the flat portion of the lower portion of the cover portion of the second cable and the flat portion of the upper portion of the cover portion of the third cable are separated from each other, the flat portion of the right portion of the cover portion of the third cable and the flat portion of the left portion of the cover portion of the fourth cable are separated from each other, or the flat portion of the upper portion of the cover portion of the fourth cable and the flat portion of the lower portion of the cover portion of the first cable are separated from each other. In the above connector device of the present invention, the plurality of cables may include a first cable, a second cable, a third cable, and a fourth cable, an outer profile of a cross section of the cover portion of each of the first cable, the second cable, the third cable and the fourth cable may be quadrilateral, wherein the back portions of the portions surrounded by the housing in the first cable, the second cable, the third cable, and the fourth cable may be arranged such that the left surface of the cover portion of the first cable and the right surface of the cover portion of the second cable are in contact with each other, the lower surface of the cover portion of the second cable and the upper surface of the cover portion of the third cable are in contact with each other, the right surface of the cover portion of the third cable and the left surface of the cover portion of the fourth cable are in contact with each other, and the upper surface of the cover portion of the fourth cable and the lower surface of the cover portion of the first cable are in contact with each other, and the front portions of the portions surrounded by the housing in the first cable, the second cable, the third cable, and the fourth cable may be arranged such that the left surface of the cover portion of the first cable and the right surface of the cover portion of the second cable are separated from each other, the lower portion of the cover portion of the second cable and the upper surface of the cover portion of the third cable are separated from each other, the right surface of the cover portion of the third cable and the left surface of the cover portion of the fourth cable are separated from each other, or the upper surface of the cover portion of the fourth cable and the lower surface of the cover portion of the first cable are separated from each other. The above connector device of the present invention may include a cable position regulating member for regulating positions of the respective cover portions of the two adjacent cables in the plurality of cables to form the spaced portion between the respective cover portions of the two cables. In the connector device of the present invention, the cable position regulating member may be coupled to the connection part.

In addition, in order to solve the above problems, a method of manufacturing a connector device is a manufacturing method of the connector device including a connection part whose one end portion is connected to a connecting object, a plurality of cables extending from the other end portion of the connection part, and a housing, wherein each of the plurality of cables has a core portion and a cover portion covering an outer circumference of the core portion, a flat portion is formed on an outer circumferential surface of the cover portion of each of the plurality of cables, one end portions of the plurality of cables are arranged in parallel such that the flat portions of the respective cover portions of the two adjacent cables in the plurality of cables are in contact with each other, and there is no space formed by separating the respective cover portions of the two adjacent cables in the plurality of cables within a cross section of a whole of the plurality of cables, and the housing surrounds a portion from the other end portion of the connection part to one end portions of the respective cover portions of the plurality of cables, and is integrated with the portion, the method includes a cable attachment step of attaching the plurality of cables to the connection part such that the plurality of cables extend from the other end portion of the connection part, a cable arrangement step of arranging one end portions of the plurality of cables in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and a housing formation step of forming the housing by overmolding on an outer circumference of the portion from the other end portion of the connection part to one end portions of the respective cover portions of the plurality of cables.

In the above method of manufacturing the connector device of the present invention, the plurality of cables may extend backwardly from a back end portion of the connection part, and the housing may be a resin molded product which surrounds a portion from a back end portion of the connection part to front end portions of the respective cover portions of the plurality of cables and is integrated with the portion by overmolding, back portions of portions surrounded by the housing in the plurality of cables may be arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and front portions of the portions surrounded by the housing in the plurality of cables may be arranged in parallel so as to form a spaced portion where the respective cover portions of the two adjacent cables in the plurality of cables are separated from each other, wherein in the cable attachment step, the plurality of cables may be attached to the connection part such that the plurality of cables extend backward from the back end portion of the connection part, in the cable arrangement step, the back portions of the portions surrounded by the housing in the plurality of cables may be arranged in a mold such that the flat portions of the respective cover portions of the two adjacent cables in the plurality of cables are in contact with each other and there is no space formed by separating the respective cover portions of the two adjacent cables in the plurality of cables within the cross section of the whole of the plurality of cables, and the front portions of the portions surrounded by the housing in the plurality of cables may be arranged in the mold such that the spaced portion is formed, in the housing formation step, resin may injected into the mold to form the housing by overmolding on the outer circumference of the portion from the back end portion of the connection part to the front end portions of the respective cover portions of the plurality of cables, a cable position regulating piece is put or formed in the mold, the cable position regulating piece regulates positions of the respective cover portions of the two adjacent cables in the plurality of cables to form the spaced portion between the respective cover portions of the two cables, and when the plurality of cables are arranged in the mold in the cable arrangement step, the cable position regulating piece is inserted between the respective cover portions of the two adjacent cables in the plurality of cables to form the spaced portion between the respective cover portions of the two cables.

### Effect of Invention

According to the present invention, in a connector device, it is possible to enhance strength to hold cables or liquid stopping performance by molding a housing covering a connection part and one ends of the cables, and to suppress the molding failure of the housing.

### BRIEF DESCRIPTION OF THE DRAWING

FIG. 1 is a perspective view showing a connector device and a counter connector, according to a first embodiment of the present invention;

FIG. 2 is a perspective view showing the connector device according to the first embodiment of the present invention, as viewed from the oblique front side;

FIG. 3 is a perspective view showing the connector device according to the first embodiment of the present invention, as viewed from the oblique back side;

FIG. 4 is a perspective view showing the connector device with no back housing provided, according to the first embodiment of the present invention;

FIG. 5 is an exploded view showing a connector part of the connector device according to the first embodiment of the present invention;

FIG. 6A is a perspective view showing a cable in the connector device according to the first embodiment of the present invention;

FIG. 6B is a cross-sectional view showing the cable taken along the line A-A in FIG. 6A, as viewed from the back side;

FIG. 6C is a cross-sectional view showing four cables arranged in the connector device according to the first embodiment of the present invention;

FIG. 7 is a perspective view showing a state where the four cables are wired in different paths, in the connector device according to the first embodiment of the present invention;

FIG. 8A is an external view showing the connector device according to the first embodiment of the present invention, as viewed from the upper side;

FIG. 8B is a cross-sectional view showing the connector device taken along the line B-B in FIG. 8A, as viewed from the right side;

FIG. 9A is a cross-sectional view showing the connector device taken along the line C-C in FIG. 8B, as viewed from the back side;

FIG. 9B is a cross-sectional view showing the connector device taken along the line D-D in FIG. 8B, as viewed from the back side;

FIG. 10A is an explanatory diagram showing a step in a method of manufacturing the connector device according to the first embodiment of the present invention;

FIG. 10B is an explanatory diagram showing a step in the method of manufacturing the connector device according to the first embodiment of the present invention;

FIG. 10C is an explanatory diagram showing a step in the method of manufacturing the connector device according to the first embodiment of the present invention;

FIG. 11A is an explanatory diagram showing a cable arrangement step in the method of manufacturing the connector device according to the first embodiment of the present invention;

FIG. 11B is an explanatory diagram showing the cable arrangement step in the method of manufacturing the connector device according to the first embodiment of the present invention;

FIG. 11C is an explanatory diagram showing a housing formation step in the method of manufacturing the connector device according to the first embodiment of the present invention;

FIG. 12A is a cross-sectional view showing the connector device and a mold taken along the line E-E in FIG. 11B, as viewed from the back side;

FIG. 12B is a cross-sectional view showing the connector device and the mold taken along the line F-F in FIG. 11B, as viewed from the back side;

FIG. 13A is an explanatory diagram showing cables each of which has a chamfered rectangular covering portion according to the first embodiment of the present invention;

FIG. 13B is an explanatory diagram showing a modified example of the housing formation step in the method of manufacturing the connector device according to the first embodiment of the present invention;

FIG. 14 is a perspective view showing a modified example of the connector device according to the first embodiment of the present invention;

FIG. 15A is a perspective view showing a connector device according to a second embodiment of the present invention, as viewed from the oblique back side;

FIG. 15B is a perspective view showing the connector device according to the second embodiment of the present invention with no back housing provided;

FIG. 16A is a perspective view showing a cable position regulating member in the connector device according to the second embodiment of the present invention, as viewed from the oblique front side;

FIG. 16B is a perspective view showing the cable position regulating member according to the second embodiment of the present invention, as viewed from the oblique back side;

FIG. 16C is a perspective view showing the cable position regulating member attached to the cables according to the second embodiment of the present invention;

FIG. 16D is an explanatory diagram showing the cable position regulating member according to the second embodiment of the present invention, as viewed from the upper side;

FIG. 16E is a cross-sectional view showing the cable position regulating member taken along the line G-G in FIG. 16D, as viewed from the back side;

FIG. 16F is a cross-sectional view showing the cable position regulating member taken along the line H-H in FIG. 16D, as viewed from the back side;

FIG. 17A is an external view showing the connector device according to the second embodiment of the present invention, as viewed from the upper side;

FIG. 17B is a cross-sectional view showing the connector device taken along the line I-I in FIG. 17A, as viewed from the right side;

FIG. 18A is a cross-sectional view showing the connector device taken along the line J-J in FIG. 17B, as viewed from the back side;

FIG. 18B is a cross-sectional view showing the connector device taken along the line K-K in FIG. 17B, as viewed from the back side;

FIG. 18C is a cross-sectional view showing the connector device taken along the line L-L in FIG. 17B, as viewed from the back side;

FIG. 18D is a cross-sectional view showing the connector device taken along the line M-M in FIG. 17B, as viewed from the back side;

FIG. 19A is an explanatory diagram showing a cable arrangement step in a method of manufacturing the connector device according to the second embodiment of the present invention;

FIG. 19B is an explanatory diagram showing the cable arrangement step in the method of manufacturing the connector device according to the second embodiment of the present invention;

FIG. 19C is an explanatory diagram showing a housing formation step in the method of manufacturing the connector device according to the second embodiment of the present invention;

FIG. 20A is an explanatory diagram showing a modified example of the cable position regulating member in the connector device according to the second embodiment of the present invention;

FIG. 20B is an explanatory diagram showing a modified example of the cable position regulating member shown in FIG. 20A and cables;

FIG. 21A is an explanatory diagram showing a modified example of the cable position regulating member in the connector device according to the second embodiment of the present invention;

FIG. 21B is an explanatory diagram showing the modified example of the cable position regulating member shown in FIG. 21A and cables;

FIG. 22A is a perspective view showing a connector device according to a third embodiment of the present invention, as viewed from the obliquely back side;

FIG. 22B is a perspective view showing the connector device according to the third embodiment of the present invention with no back housing provided;

FIG. 23A is a perspective view showing a connector part of the connector device according to the third embodiment of the present invention;

FIG. 23B is an exploded view of a cover in the connector part of the connector device according to the third embodiment of the present invention;

FIG. 23C is a perspective view showing the cable position regulating part in an intermediate cover member of the connector part of the connector device according to the third embodiment of the present invention;

FIG. 23D is a perspective view showing the back portion of the connector part to which the cables are attached, according to the third embodiment of the present invention;

FIG. 24A is an external view showing the connector device according to the third embodiment of the present invention, as viewed from the upper side;

FIG. 24B is a cross-sectional view showing the connector device taken along the line P-P in FIG. 24A, as viewed from the right side;

FIG. 25A is a cross-sectional view showing the connector device taken along the line Q-Q in FIG. 24B, as viewed from the back side;

FIG. 25B is a cross-sectional view showing the connector device taken along the line R-R in FIG. 24B, as viewed from the back side;

FIG. 25C is a cross-sectional view showing the connector device taken along the line S-S in FIG. 24B, as viewed from the back side;

FIG. 26A is an explanatory diagram showing a mold for molding a back housing of the connector device according to a fourth embodiment of the present invention;

FIG. 26B is an explanatory diagram showing the mold in FIG. 26A;

FIG. 26C is an explanatory diagram showing a state in which the cables are arranged in the mold, according to the fourth embodiment of the present invention;

FIG. 26D is an explanatory diagram showing a state in which a cable position regulating piece provided in the mold is inserted between the cover portions of the cable, according to the fourth embodiment of the present invention;

FIG. 27A is an explanatory diagram showing a modified example of the plurality of cables in the connector device according to each embodiment of the present invention;

FIG. 27B is an explanatory diagram showing a modified example of the plurality of cables in the connector device according to each embodiment of the present invention;

FIG. 27C is an explanatory diagram showing a modified example of the plurality of cables in the connector device according to each embodiment of the present invention;

FIG. 27D is an explanatory diagram showing a modified example of the plurality of cables in the connector device according to each embodiment of the present invention;

FIG. 27E is an explanatory diagram showing a modified example of the plurality of cables in the connector device according to each embodiment of the present invention;

FIG. 27F is an explanatory diagram showing a modified example of the plurality of cables in the connector device according to each embodiment of the present invention;

FIG. 28 is a perspective view showing a housing formed by overmolding, in a connector device as a comparative example;

FIG. 29A is an explanatory diagram showing a step in a method of manufacturing the connector device in FIG. 28;

FIG. 29B is an explanatory diagram showing a step in the method of manufacturing the connector device in FIG. 28;

FIG. 30A is an explanatory diagram showing a housing formation step in the method of manufacturing the connector device in FIG. 29B;

FIG. 30B is an explanatory diagram showing a housing formation step in the method of manufacturing the connector device in FIG. 29B;

FIG. 31A is an explanatory diagram showing an example in which a space is formed in a cross section of the plurality of arranged cables by partially separating the respective cover portions of two adjacent cables of the plurality of cables;

FIG. 31B is an explanatory diagram showing an example in which a space is formed in a cross section of the plurality of arranged cables by partially separating the respective cover portions of two adjacent cables of the plurality of cables;

FIG. 31C is an explanatory diagram showing an example in which a space is formed in a cross section of the plurality of arranged cables by partially separating the respective cover portions of two adjacent cables of the plurality of cables;

FIG. 32A is an explanatory diagram showing an example in which the plurality of cables each having a circular cross-sectional shape are arranged in a horizontal row;

FIG. 32B is an explanatory diagram showing an example in which the plurality of cables each having a circular cross-sectional shape are arranged apart from each other; and

FIG. 33 is an explanatory diagram showing a case in which the four cables of the connector device as the comparative example are arranged between two molds in which a recess having a quadrilateral cross-sectional shape having four internal angles of 90 degrees is formed.

### DETAILED DESCRIPTION

Hereinafter, some embodiments of a connector device and a manufacturing method of the connector device according to the present invention will be described with reference to the drawings. In the description of the respective embodiments, the directions of front (Fd), back (Bd), left (Ld), right (Rd), up (Ud), and down (Dd) are described in accordance with the arrows drawn at the lower left portion in each figure for convenience of explanation.

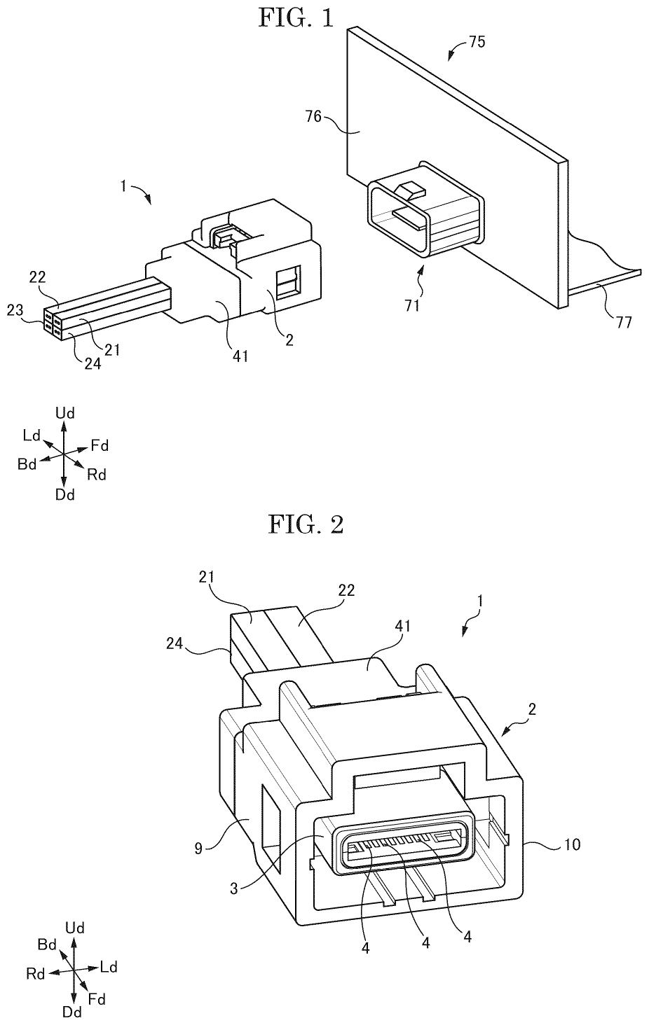

(First Embodiment) First, with reference to FIGS. 1 to 14, a connector device according to a first embodiment of the present invention will be described.

[Connector Device] FIG. 1 shows a connector device 1 according to the first embodiment of the present invention and a counter connector 71 to which the connector device 1 can be connected. The counter connector 71 is attached, for example, to a part of a housing 76 of an electrical/electronic apparatus 75. Although not shown, the counter connector 71 includes a plurality of terminals, and each terminal is electrically connected to a circuit provided on a substrate 77 of the electrical/electronic apparatus 75. The counter connector 71 is a specific example of “connecting object”.

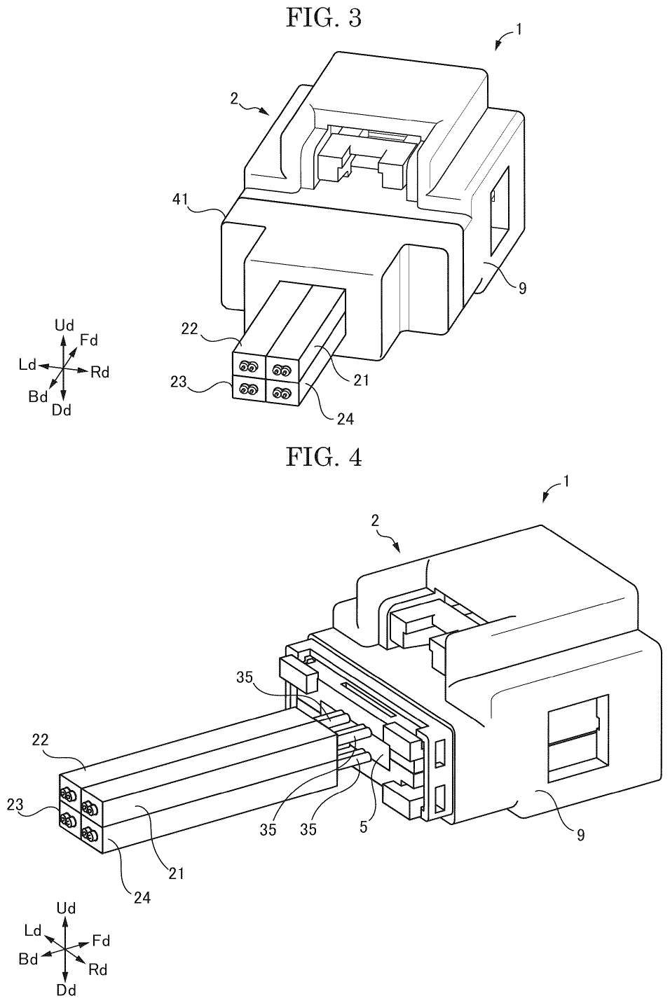

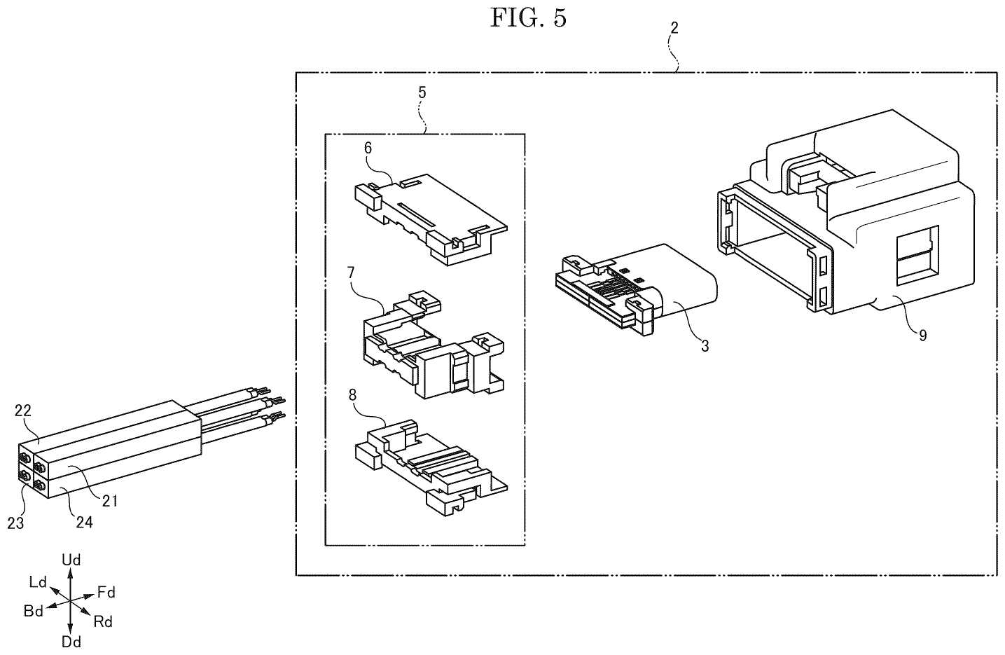

FIG. 2 shows the connector device 1 as viewed from the oblique front side. FIG. 3 shows the connector device 1 as viewed from the oblique back side. FIG. 4 shows the connector device 1 with no back housing 41. FIG. 5 shows a state in which the connector device 1 with no back housing 41 is disassembled.

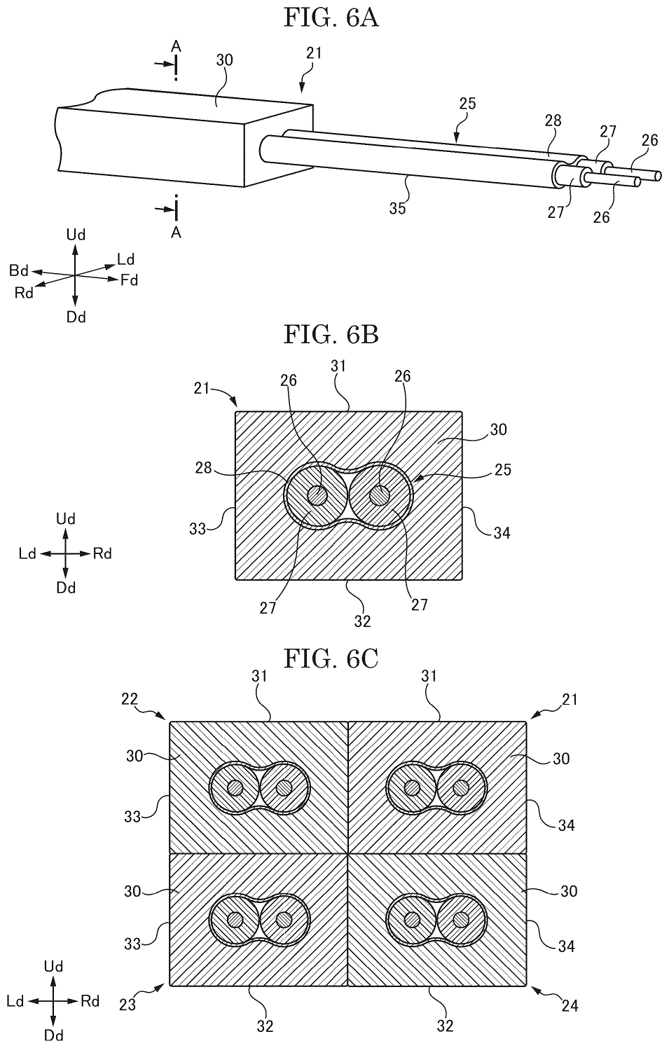

As shown in FIG. 3, the connector device 1 includes a connector part 2, four cables 21, 22, 23 and 24, and a back housing 41. As shown in FIG. 5, the connector part 2 includes a body part 3, a cover 5, and a connector housing 9. The cover 5 includes an upper cover member 6, an intermediate cover member 7, and a lower cover member 8. The connector part 2 is a specific example of “connection part” and the back housing 41 is a specific example of “housing”.

[Cable] FIG. 6A shows the cable 21 which is one of the four cables 21 to 24 of the connector device 1. As shown in FIG. 6A, the cable 21 is a two-core shield cable, such as a twinax cable. The cable 21 has a core portion 25 and a cover portion 30. The core portion 25 has two conductive wires 26, two insulators 27, and a shield conductor 28. The outer circumference of each conductive wire 26 is covered with the insulator 27. The circumferences of the two conductive wires 26 covered with the insulators 27 are collectively covered with the shield conductor 28. The circumference of the core portion 25 formed in the above manner is covered with the cover portion 30. The cover portion 30 is made of insulative material such as resin.

An exposed portion 35 exposed from the cover portion 30 is formed at the front end portion (one end portion) of the core portion 25 of the cable 21. That is, at the time of manufacturing the connector device 1, the distal end portion in the front end portion of the cover portion 30 of the cable 21 is cut off, and the front end portion of the core portion 25 is exposed from the cover portion 30.

FIG. 6B shows a cross section of the cable 21 taken along the line A-A in FIG. 6A, as viewed from the back side (the left side in FIG. 6A). The cover portion 30 is formed in a quadrilateral cylindrical shape, and as shown in FIG. 6B, the outer profile of the cross section of the cover portion 30 is a quadrilateral, and more specifically, a quadrilateral having four internal angles of 90 degrees, for example, a rectangle. On the outer circumferential surface of the cover portion 30, an upper surface 31, a lower surface 32, a left surface 33, and a right surface 34 are formed. The upper surface 31, the lower surface 32, the left surface 33, and the right surface 34 are flat. The upper surface 31, the lower surface 32, the left surface 33, and the right surface 34 are a specific example of “flat portion”.

FIG. 6C shows the four cables 21 to 24 arranged in two rows in the upper-and-lower direction and in two rows in the left-and-right direction. The cables 22, 23 and 24 have the same configuration as the cable 21. As shown in FIG. 6C, the cross-sectional shapes of the cover portions 30 of the cables 21 to 24 are congruent with each other.

In the connector device 1, portions on the back side of the exposed portions 35 of the front end portions of the cables 21 to 24 are arranged in parallel such that the upper surface 31, the lower surface 32, the left surface 33 or the right surface 34 of the cover portion 30 of one cable of the two adjacent cables in the cables 21 to 24 and the upper surface 31, the lower surface 32, the left surface 33 or the right surface 34 of the cover portion 30 of the other cable of the two adjacent cables in the cables 21 to 24 are in contact with each other. The portions on the back side of the exposed portions 35 of the front end portions of the cables 21 to 24 are arranged such that there is no space formed by wholly or partially separating the respective cover portions 30 of the two adjacent cables in the cables 21 to 24 within a cross section of the whole of the portions of the cables 21 to 24.

Specifically, as shown in FIG. 6C, the portions on the back side of the exposed portions of the front end portions of the cables 21 to 24 are arranged in two rows in the upper-and-lower direction and in two rows in the left-and-right direction. More specifically, when the connector device 1 is viewed from the back side, the cable 22 is arranged on the left side of the cable 21, the cable 23 is arranged below the cable 22, the cable 24 is arranged on the right side of the cable 23, and the cable 21 is arranged above the cable 24. The positions of the cables 21 and 24 arranged on the right side are the same as each other in the left-and-right direction. That is, in the cables 21 and 24, the positions of the right surfaces 34 of the respective cover portions 30 are the same as each other in the left-and-right direction, and the positions of the left surfaces 33 of the respective cover portions 30 are the same as each other in the left-and-right direction. The positions of the cables 22 and 23 arranged on the left side are the same as each other in the left-and-right direction. That is, in the cables 22 and 23, the positions of the right surfaces 34 of the respective cover portions 30 are the same as each other in the left-and-right direction, and the positions of the left surfaces 33 of the respective cover portions 30 are the same as each other in the left-and-right direction. The positions of the cables 21 and 22 arranged on the upper side are the same as each other in the upper-and-lower direction. That is, in the cables 21 and 22, the positions of the upper surfaces 31 of the respective cover portions 30 are the same as each other in the upper-and-lower direction, and the positions of the lower surfaces 32 of the respective cover portions 30 are the same as each other in the upper-and-lower direction. The positions of the cables 23 and 24 arranged on the lower side are the same as each other in the upper-and-lower direction. That is, in the cables 23 and 24, the positions of the upper surfaces 31 of the respective cover portions 30 are the same as each other in the upper-and-lower direction, and the positions of the lower surfaces 32 of the respective cover portions 30 are the same as each other in the upper-and-lower direction.

The portions on the back side of the exposed portions 35 of the front end portions of the cables 21 to 24 are arranged such that no space is formed between the respective cover portions 30 of the adjacent cables in the cables 21 to 24. That is, the left surface 33 of the cover portion 30 of the cable 21 and the right surface 34 of the cover portion 30 of the cable 22 are in contact with each other. The lower surface 32 of the cover portion 30 of the cable 22 and the upper surface 31 of the cover portion 30 of the cable 23 are in contact with each other. The right surface 34 of the cover portion 30 of the cable 23 and the left surface 33 of the cover portion 30 of the cable 24 are in contact with each other. The upper surface 31 of the cover portion 30 of the cable 24 and the lower surface 32 of the cover portion 30 of the cable 21 are in contact with each other.

In the portions on the back side of the exposed portions 35 of the front end portions of the cables 21 to 24, the outer profile of the cross section of all the cables 21 to 24 is a quadrilateral having four internal angles of 90 degrees, for example, a rectangle. Further, in the portions on the back side of the exposed portions 35 of the front end portions of the cables 21 to 24, there is no space formed by wholly or partially separating the respective cover portions 30 of the two adjacent cables in the cables 21 to 24 within the cross section of the whole of the cables 21 to 24.

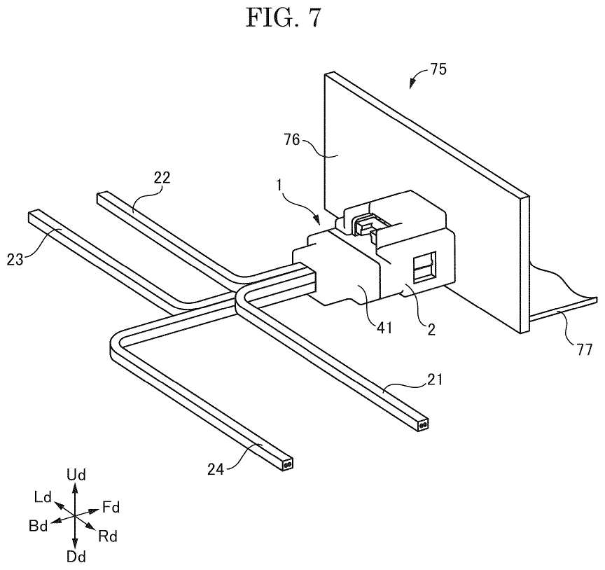

The cables 21 to 24 are independent. That is, in a stage before the cables 21 to 24 are attached to the connector part 2, the cables 21 to 24 can be completely separated from each other. After the cables 21 to 24 are attached to the connector part 2, in the cables 21 to 24, portions other than the portions attached to the connector part 2 can be separated from each other. Thus, for example, as shown in FIG. 7, the routing paths of the cables 21 to 24 can be made different from each other.

[Connector Part] In FIG. 5, the body part 3 of the connector part 2 is made of insulative material such as resin. As shown in FIG. 2, a plurality of contacts 4 made of conductive material such as metal are provided at the front end portion of the body part 3. Although not shown in detail, a plurality of conductive portions made of conductive material such as metal are provided at the back end portion of the body part 3, and the front end portions of the conductive wires 26 of the core portions 25 of the four cables 21 to 24 are connected to the conductive portions by means of, for example, soldering. In the body part 3, a circuit for connecting the plurality of contacts 4 and the plurality of conductive portions is formed. When the connector device 1 is connected to the counter connector 71, the contacts 4 of the connector device 1 are in contact with the contacts provided on the counter connector 71. Then, the connector device 1 and the counter connector 71 are electrically connected to each other.

In the connector part 2, as shown in FIG. 4, the cover 5 has a function of closing the back end portion (other end portion) of the connector part 2, specifically, the back opening of the connector housing 9, while holding the respective exposed portions 35 of the cables 21 to 24. As shown in FIG. 5, the intermediate cover member 7, the upper cover member 6 and the lower cover member 8 constituting the cover 5 are each made of insulative material such as resin. The upper cover member 6 is assembled to the upper portion of the intermediate cover member 7, and the lower cover member 8 is assembled to the lower portion of the intermediate cover member 7. The respective exposed portions 35 of the cables 21 and 22 are held between the intermediate cover member 7 and the upper cover member 6. The respective exposed portions 35 of the cables 23 and 24 are held between the intermediate cover member 7 and the lower cover member 8.

In the connector part 2, the connector housing 9 is made of insulative material such as resin, and formed in a quadrilateral cylindrical shape. The body part 3 and the cover 5 are arranged and held inside the connector housing 9. Further, as shown in FIG. 2, a fitting part 10 fitted with the counter connector 71 is formed on the front end portion of the connector housing 9.

[Back Housing] As shown in FIG. 3, the back housing 41 is provided at the back portion of the connector part 2. The back housing 41 is made of insulative material, such as resin, more specifically, material with good filling properties, such as polyamide hot melt, olefin hot melt, ethylene vinyl acetate hot melt, or polyurethane hot melt. The back housing 41 surrounds a portion from the back end portion of the connector part 2 to the front end portions of the respective cover portions 30 of the cables 21 to 24. Specifically, as shown in FIG. 4, the back end portions of the exposed portions 35 of the respective core portions 25 of the cables 21 to 24 extend out of the back end portion of the connector part 2 to the outside of the connector part 2. The back housing 41 surrounds the back end portion of the connector part 2, the back end portions of the exposed portions 35 of the respective core portions 25 of the cables 21 to 24, and the front end portions of the respective cover portions 30 of the cables 21 to 24.

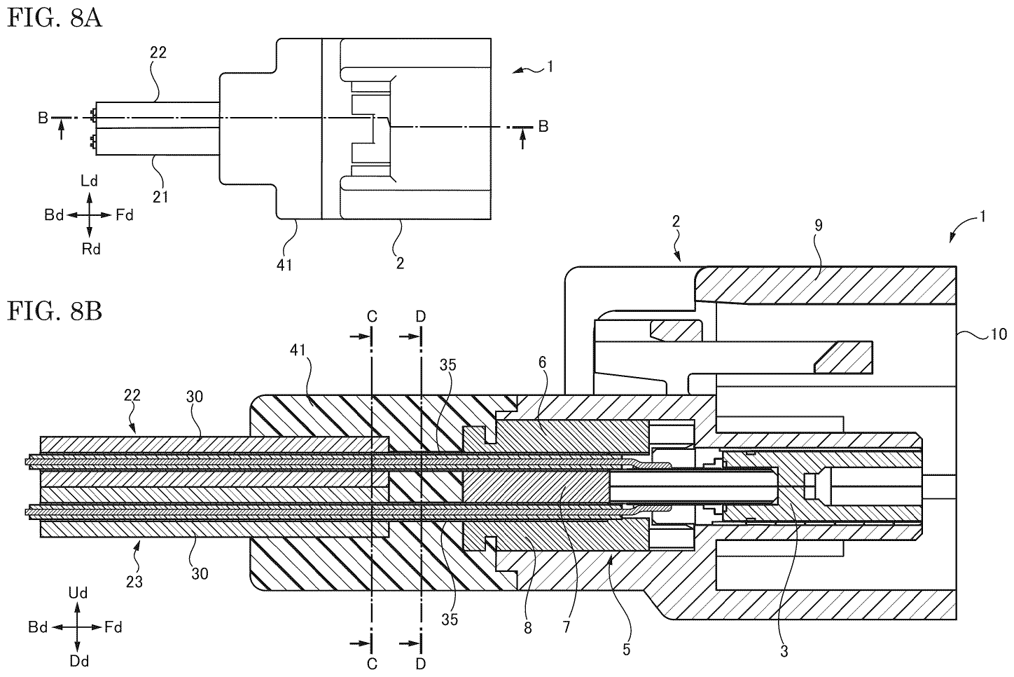

FIG. 8A shows the connector device 1 as viewed from the upper side. FIG. 8B shows a cross section of the connector device 1 taken along the line B-B in FIG. 8A as viewed from the right side (the lower side in FIG. 8A). As shown in FIG. 8B, the back housing 41 is formed by overmolding on the circumference of the portion from the back end portion of the connector part 2 to the front end portions of the respective cover portions 30 of the cables 21 to 24, and is integrated with the back end portion of the connector part 2, the back end portions of the exposed portions 35 of the respective core portions 25 of the cables 21 to 24, and the front end portions of the respective cover portions 30 of the cables 21 to 24.

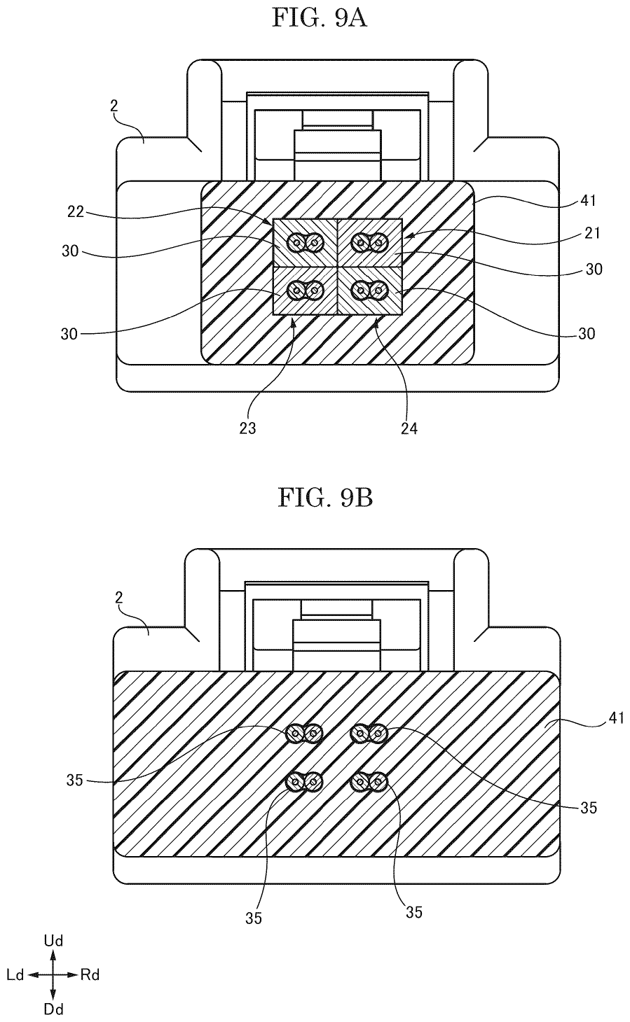

FIG. 9A shows a cross section of the connector device 1 taken along the line C-C in FIG. 8B as viewed from the back side (the left side in FIG. 8B). As shown in FIG. 9A, the front end portions of the cover portions 30 of the cables 21 to 24 arranged in two rows in the upper-and-lower direction and in two rows in the left-and-right direction as described above are buried in the resin for forming the back housing 41. The entire outer circumference of all the front end portions of the cover portions 30 of the cables 21 to 24 is covered with the resin for forming the back housing 41. The resin for forming the back housing 41 is in close contact (more specifically, liquid-tight contact) with the right surface 34 and the upper surface 31 of the front end portion of the cover portion 30 of the cable 21. Similarly, the resin for forming the back housing 41 is in close contact with the left surface 33 and the upper surface 31 of the front end portion of the cover portion 30 of the cable 22, the left surface 33 and the lower surface 32 of the front end portion of the cover portion 30 of the cable 23, and the right surface 34 and the lower surface 32 of the front end portion of the cover portion 30 of the cable 24.

As shown in FIG. 9A, in the front end portions of the cover portions 30 of the cables 21 to 24, the flat surfaces of the cover portions 30 facing each other are in close contact with each other over the entire areas. That is, the left surface 33 of the cover portion 30 of the cable 21 and the right surface 34 of the cover portion 30 of the cable 22, the lower surface 32 of the cover portion 30 of the cable 22 and the upper surface 31 of the cover portion 30 of the cable 23, the right surface 34 of the cover portion 30 of the cable 23 and the left surface 33 of the cover portion 30 of the cable 24, and the upper surface 31 of the cover portion 30 of the cable 24 and the lower surface 32 of the cover portion 30 of the cable 21 are in close contact with each other over the entire areas.

FIG. 9B shows a cross section of the connector device 1 taken along the line D-D in FIG. 8B as viewed from the back side (the left side in FIG. 8B). As shown in FIG. 9B, the back end portion of the exposed portion 35 of the core portion 25 of each of the cables 21 to 24 is buried in the resin for forming the back housing 41. The entire outer circumference of the exposed portion 35 of the core portion 25 of each of the cables 21 to 24 is covered with the resin for forming the back housing 41. Further, the resin for forming the back housing 41 is in close contact (more specifically, liquid-tight contact) with the entire outer circumferential surface of the back end portion of the exposed portion 35 of the core portion 25 of each of the cables 21 to 24.

As shown in FIGS. 3 and 8B, the back end portion of the connector part 2, specifically, the back surface of the cover 5, the back end surface of the connector housing 9, and the outer circumferential surface of the back end portion of the connector housing 9 are covered with the resin for forming the back housing 41, and the resin is in close contact with these portions.

[Liquid Stopping Function and Cable Holding Function of Connector Device] As described later, the back housing 41 is formed by filling a mold with molten resin and then solidifying the resin. Therefore, in FIG. 9A, a degree of adhesion between the outer circumferential surface of all the front end portions of the cover portions 30 of the cables 21 to 24 and the resin for forming the back housing 41 is extremely high. That is, a degree of adhesion between the right surface 34 and the upper surface 31 of the front end portion of the cover portion 30 of the cable 21 and the resin for forming the back housing 41, a degree of adhesion between the left surface 33 and the upper surface 31 of the front end portion of the cover portion 30 of the cable 22 and the resin forming the back housing 41, a degree of adhesion between the left surface 33 and the lower surface 32 of the front end portion of the cover portion 30 of the cable 23 and the resin for forming the back housing 41, and a degree of adhesion between the right surface 34 and the lower surface 32 of the front end portion of the cover portion 30 of the cable 24 and the resin for forming the back housing 41 are extremely high. By such close contact between the cover portions 30 and the back housing 41, it becomes possible to prevent a liquid from entering between the front end portions of the cover portions 30 of the cables 21 to 24 and the back housing 41, and to hold the cables 21 to 24 firmly by the back housing 41.

Similarly, in FIG. 9B, a degree of adhesion between the outer circumferential surface of the back end portion of the exposed portion 35 of the core portion 25 of each of the cables 21 to 24 and the resin for forming the back housing 41 is also extremely high. By such close contact between the exposed portion 35 of the core portion 25 and the back housing 41, it becomes possible to prevent a liquid from entering between the back end portion of the exposed portion 35 of the core portion 25 of each of the cables 21 to 24 and the back housing 41, and to hold the back end portion of the exposed portion 35 of the core portion 25 of each of the cables 21 to 24 firmly by the back housing 41.

Similarly, a degree of adhesion between the back end portion of the connector part 2 and the resin for forming the back housing 41 is also extremely high. By such close contact between the back end portion of the connector part 2 and the back housing 41, it becomes possible to prevent a liquid from entering between the back end portion of the connector part 2 and the back housing 41.

When the back housing 41 is molded, the resin for forming the back housing 41 is filled on the entire circumference of all the front end portions of the cover portions 30 of the cables 21 to 24. At this time, the outer circumference of all the front end portions of the cover portions 30 of the cables 21 to 24 is pressed inward by a pressure of the resin to be filled. As a result, in the front end portions of the cover portions 30 of the cables 21 to 24, the flat surfaces of the cover portions 30 facing each other are firmly brought into contact with each other over the entire areas. That is, the left surface 33 of the cover portion 30 of the cable 21 and the right surface 34 of the cover portion 30 of the cable 22, the lower surface 32 of the cover portion 30 of the cable 22 and the upper surface 31 of the cover portion 30 of the cable 23, the right surface 34 of the cover portion 30 of the cable 23 and the left surface 33 of the cover portion 30 of the cable 24, and the upper surface 31 of the cover portion 30 of the cable 24 and the lower surface 32 of the cover portion 30 of the cable 21 are firmly brought into contact with each other over the entire areas. By such close contact between the flat surfaces of the cover portions 30 facing each other, it becomes possible to prevent a liquid from entering between the cover portions 30 of the cables 21 to 24.

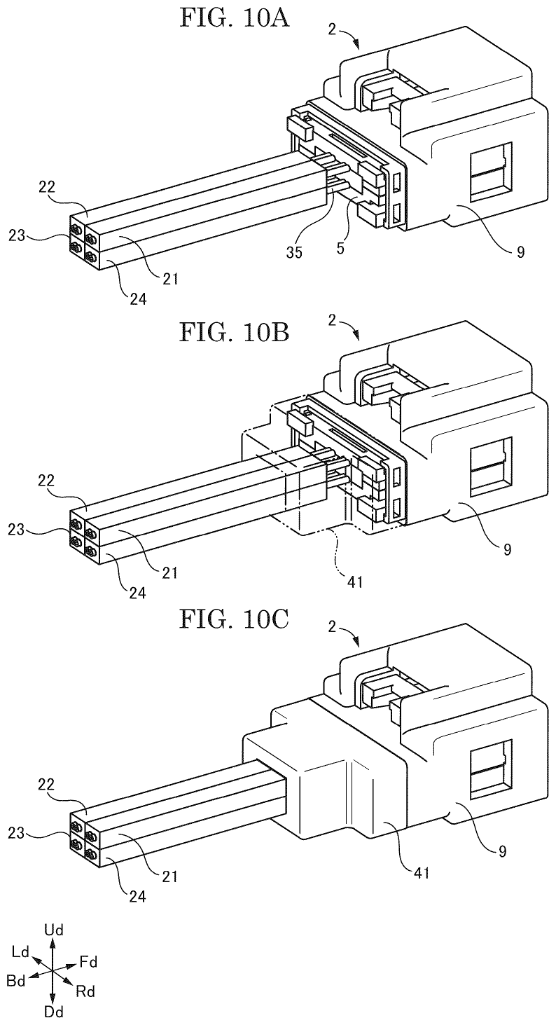

As shown in FIG. 8B, in the back portion of the back housing 41, a first liquid stopping structure is formed by the close contact between the cover portion 30 and the back housing 41 and the close contact between the flat surfaces of the cover portions 30 facing each other. In the front portion of the back housing 41, a second liquid stopping structure is formed by the close contact between the exposed portion 35 of the core portion 25 and the back housing 41. These two liquid stopping structures can reliably prevent a liquid from entering the inside of the connector part 2 from the back end of the back housing 41 through the inside of the back housing 41. For example, even if a liquid enters between the cover portions 30 due to a capillary phenomenon (even if a liquid passes through the first stopping structure), the liquid will not reach the connector part 2 because the second liquid stopping structure will surely prevent the liquid from flowing in the back housing 41 toward the connector part 2. As described above, the connector device 1 has an excellent liquid stopping performance.

[Method of Manufacturing Connector Device] FIGS. 10A, 10B and 10C show a method of manufacturing the connector device 1. In manufacturing the connector device 1, first, as shown in FIG. 6A, in each of the cables 21 to 24, the distal end of the front end portion of the cover portion 30 is cut off to expose the front end portion of the core portion 25 from the cover portion 30, so that the exposed portion 35 is formed (an exposed portion formation step).

Next, the cables 21 to 24 are attached to the connector part 2 such that the cables 21 to 24 extend from the back end portion of the connector part 2 (a cable attachment step). Specifically, while the exposed portions 35 of the respective core portions 25 of the cables 21 and 22 are arranged between the intermediate cover member 7 and the upper cover member 6, the upper cover member 6 is assembled to the intermediate cover member 7. While the exposed portions 35 of the respective core portions 25 of the cables 23 and 24 are arranged between the intermediate cover member 7 and the lower cover member 8, the lower cover member 8 is assembled to the intermediate cover member 7. Then, the front end portions of the conductive wires 26 of the respective core portions 25 of the cables 21 to 24 are connected to the body part 3 by, for example, soldering. Thereafter, the body part 3 and the cover 5 are inserted into the connector housing 9. FIG. 10A shows a state in which the cables 21 to 24 are attached to the connector part 2 in this manner.

Next, the front end portions of the cables 21 to 24 are arranged as shown in FIG. 6C (a cable arrangement step). Specifically, the connector part 2 and the front end portions of the cables 21 to 24 are arranged in the mold for forming the back housing 41. By arranging the front end portions of the cables 21 to 24 in the mold, the front end portions of the cables 21 to 24 are arranged as shown in FIG. 6C.

Then, the molten resin is injected into the mold to form the back housing 41 indicated by the two-dot chain line in FIG. 10B (a housing formation step). FIG. 10C shows the completed connector device 1.

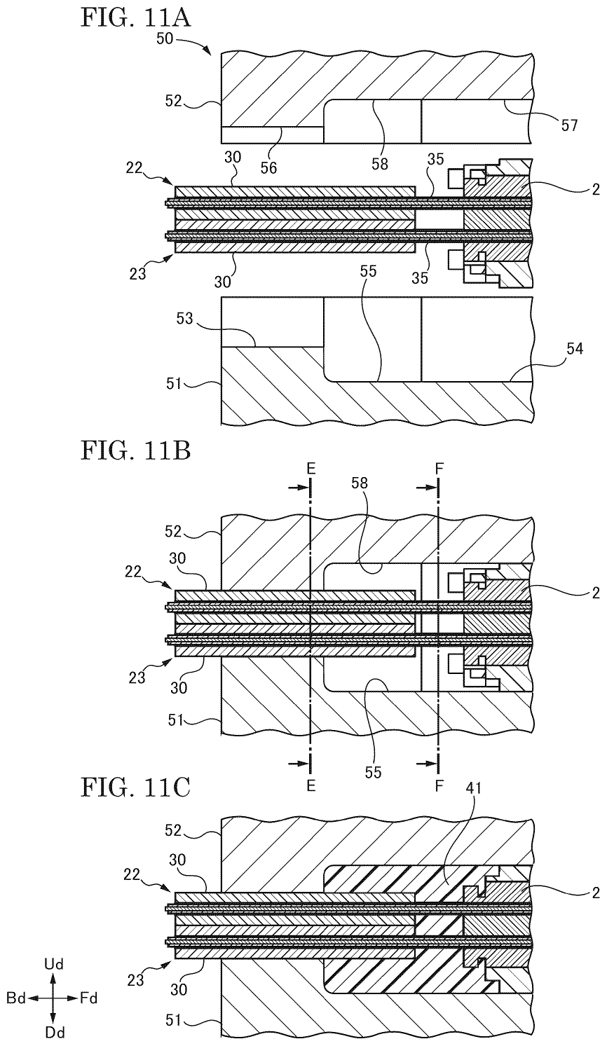

FIGS. 11A, 11B and 11C show details of the cable arrangement step and the housing formation step. In FIG. 11A, the mold 50 for forming the back housing 41 includes a first mold piece 51 and a second mold piece 52. For example, the second mold piece 52 is movable upward and downward relative to the first mold piece 51. The first mold piece 51 has a recess 53 for arranging the cable 23, the cable 24, the lower portion of the cable 21, and the lower portion of the cable 22. The first mold piece 51 has a recess 54 for arranging the lower portion of the connector part 2. The first mold piece 51 has a cavity 55 for filling the resin to form the back housing 41. The second mold piece 52 has a recess 56 for arranging the upper portions of the cables 21 and 22. The second mold piece 52 has a recess 57 for arranging the upper portion of the connector part 2. The second mold piece 52 has a cavity 58 for filling the resin to form the back housing 41.

In forming the back housing 41, the connector part 2 and the portions on the back side of the exposed portions 35 in the front end portions of the cables 21 to 24 are arranged between the first mold piece 51 and the second mold piece 52 as shown in FIG. 11B. At this time, for example, the lower portion of the connector part 2 is inserted into the recess 54 of the first mold piece 51, the portions on the back side of the exposed portions 35 in the front end portions of the cables 23 and 24 are inserted into the recess 53 of the first mold piece 51, and the lower portion of the portions on the back side of the exposed portions 35 of the front end portions of the cables 21 and 22 are inserted into the recess 53 of the first mold piece 51. Then, when the second mold piece 52 is attached to the first mold piece 51, the upper portion of the connector part 2 is inserted into the recess 57 of the second mold piece 52, and the upper portions of the portions on the back side of the exposed portions 35 in the front end portions of the cables 21 and 22 are inserted into the recess 56 of the second mold piece 52. In this manner, the connector part 2 and the portions on the back side of the exposed portions 35 in the front end portions of the cables 21 to 24 are arranged between the first mold piece 51 and the second mold piece 52, so that the portions on the back side of the exposed portions 35 in the front end portions of the cables 21 to 24 are arranged as shown in FIG. 6C. Then, as shown in FIG. 11C, the molten resin is injected into the cavities 55 and 58 of the mold 50. Thereafter, the connector device 1 in which the back housing 41 is formed is separated from the mold 50. Thus, the connector device 1 is completed.

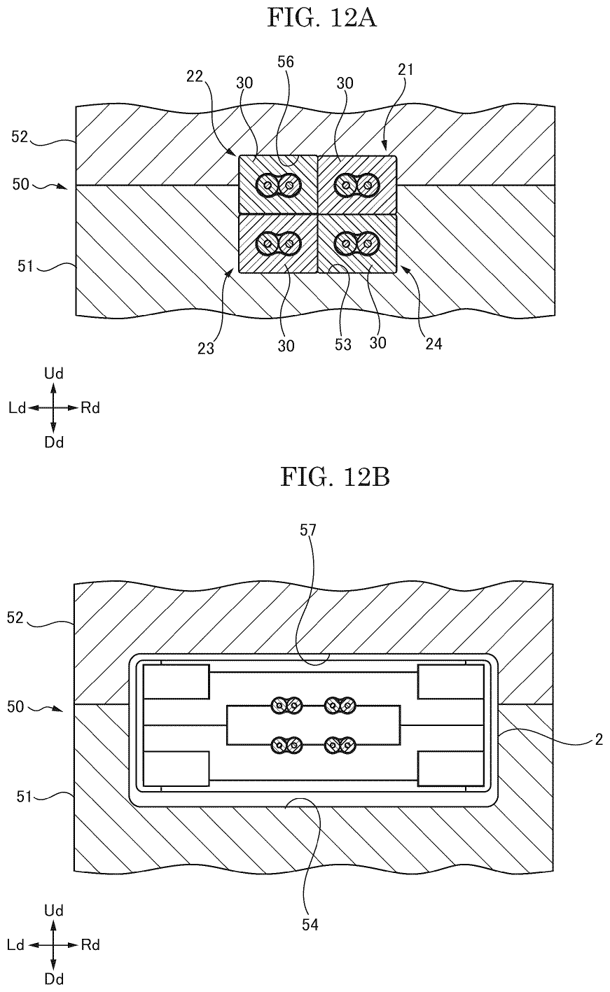

FIG. 12A shows a cross section of the cables 21 to 24 and the mold 50 taken along the line E-E in FIG. 11B as viewed from the back side (the left side in FIG. 11B). FIG. 12B shows a cross-section of the cables 21 to 24 and the mold 50 taken along the line F-F in FIG. 11B as viewed from the back side (the left side in FIG. 11B).

As shown in FIG. 12A, in the state where the connector part 2 and the front end portions of the cables 21 to 24 are arranged between the first mold piece 51 and the second mold piece 52, there is no space through which the molten resin can pass between the respective cover portions 30 of the portions on the back side of the exposed portions 35 in the front end portions of the cables 21 to 24 and the recess 53 of the first mold piece 51. That is, the shape and size of the recess 53 in the first mold piece 51 are set so as not to form such a space. Further, there is no space through which the molten resin can pass between the respective cover portions 30 of the portions on the back side of the exposed portions 35 in the front end portions of the cables 21 and 22 and the recess 56 of the second mold pieces 52. That is, the shape and size of the recess 56 in the second mold piece 52 are set so as not to form such a space. Further, as described above, the portions on the back side of the exposed portions 35 in the front end portions of the cables 21 to 24 are arranged such that there is no space by wholly or partially separating the respective cover portions 30 of the two adjacent cables in the cables 21 to 24 from each other within the cross section of the whole of the portions.

Further, as shown in FIG. 12B, in the state in which the connector part 2 and the portions on the back side of the exposed portions 35 in the front end portions of the cables 21 to 24 are arranged between the first mold piece 51 and the second mold piece 52, there is no space through which the molten resin can pass either between the lower portion of the back end portion of the connector part 2 and the recess 54 of the first mold piece 51 or between the upper portion of the back end portion of the connector part 2 and the recess 57 of the second mold piece 52. That is, the shape and size of the recess 54 in the first mold piece 51 and the shape and size of the recess 57 in the second mold piece 52 are set so as not to form such a space. The intermediate cover member 7, the upper cover member 6, the lower cover member 8, the exposed portions 35 of the cables 21 and 22 arranged between the intermediate cover member 7 and the upper cover member 6, and the exposed portions 35 of the cables 23 and 24 arranged between the intermediate cover member 7 and the lower cover member 8 are assembled so that there is no space through which the molten resin can pass.

As a result, when the molten resin is injected into the cavities 55 and 58 of the mold 50, the resin does not flow out of the mold 50. Therefore, the pressure of the resin in the mold 50 can be sufficiently increased. Accordingly, in the molding of the back housing 41, it is possible to suppress the occurrence of molding failure such as short molding.

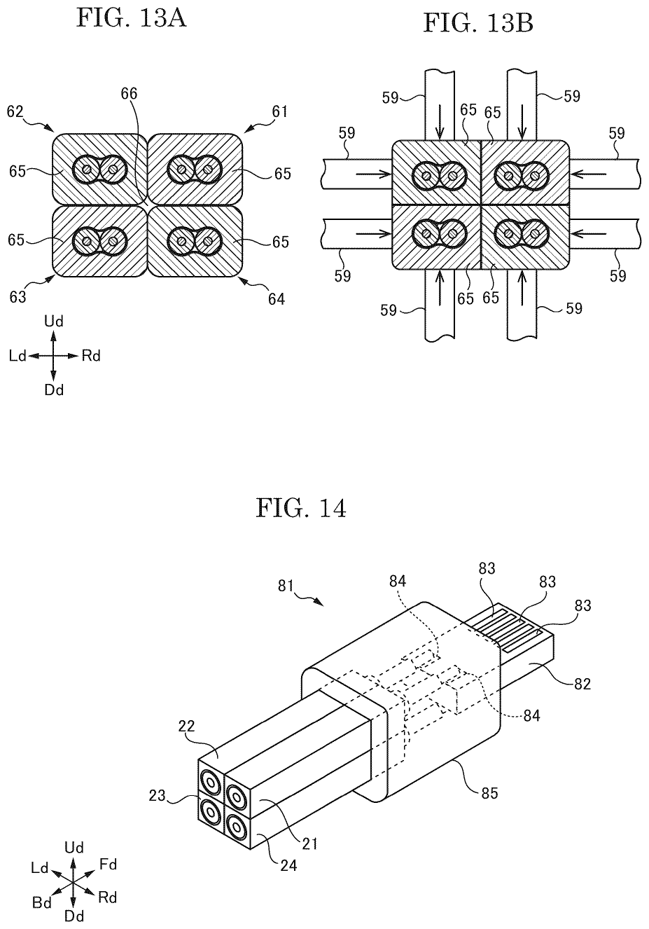

As shown in FIG. 13A, in the case where the cross section of the cover portion 65 of each of the four cables 61 to 64 is a chamfered quadrilateral, when the cables 61 to 64 are arranged in two row in the upper-and-lower direction and in two rows in the left-and-right direction, a space 66 may be formed in a portion surrounded by the left lower corner of the cover portion 65 of the cable 61, the right lower corner of the cover portion 65 of the cable 62, the right upper corner of the cover portion 65 of the cable 63, and the left upper corner of the cover portion 65 of the cable 64. In such a case, as shown in FIG. 13B, press pins 59 may be provided in the mold for forming the back housing 41, and the cover portions 65 of the portions on the back side of the exposed portions in the front end portions of the cables 61 to 64 may be pressed by the press pins 59 in the direction indicated by the arrow in FIG. 13B from the outside toward the inside. As a result, the cover portion 65 of each of the cables 61 to 64 is deformed so that the space 66 is not formed.

As described above, the connector device 1 according to the first embodiment of the present invention includes the back housing 41 which surrounds the portion from the back end portion of the connector part 2 to the front end portions of the respective cover portions 30 of the cables 21 to 24 and is integrated with the portion by overmolding. With this configuration, the strength to hold the cables 21 to 24 in the connector device 1 can be enhanced, and the liquid stopping performance of the connector device 1 can be enhanced.

In the connector device 1 of this embodiment, the back end portions of the exposed portions 35 of the respective core portions 25 of the cables 21 to 24 are exposed from the back end portion of the connector part 2 to the outside of the connector part 2, and the back housing 41 surrounds the back end portion of the connector part 2, the back end portions of the exposed portions 35 of the respective core portions 25 of the cables 21 to 24, and the front end portions of the respective cover portions 30 of the cables 21 to 24, and is integrated with the back end portion of the connector part 2, the back end portions of the exposed portions 35 of the respective core portions 25 of the cables 21 to 24, and the front end portions of the respective cover portions 30 of the cables 21 to 24 by overmolding. With this configuration, even if a liquid enters between the cover portions 30 in the front end portions of the cables 21 to 24 due to a capillary phenomenon, the liquid can be prevented from entering the connector part 2.

In the connector device 1 of the present embodiment, the back housing 41 is formed by overmolding on the outer circumference of the portion from the back end portion of the connector part 2 to the front end portions of the respective cover portions of the cables. With this configuration, even if the cable attached to the connector part 2 is a cable of low strength such as an FFC (flexible flat cable) or FPC (flexible printed circuits), the cable can be securely held in the connector part 2. In addition, the outer circumference of the cable can be liquid-tightly sealed, and a liquid can be prevented from entering the connector part 2 along the cable.

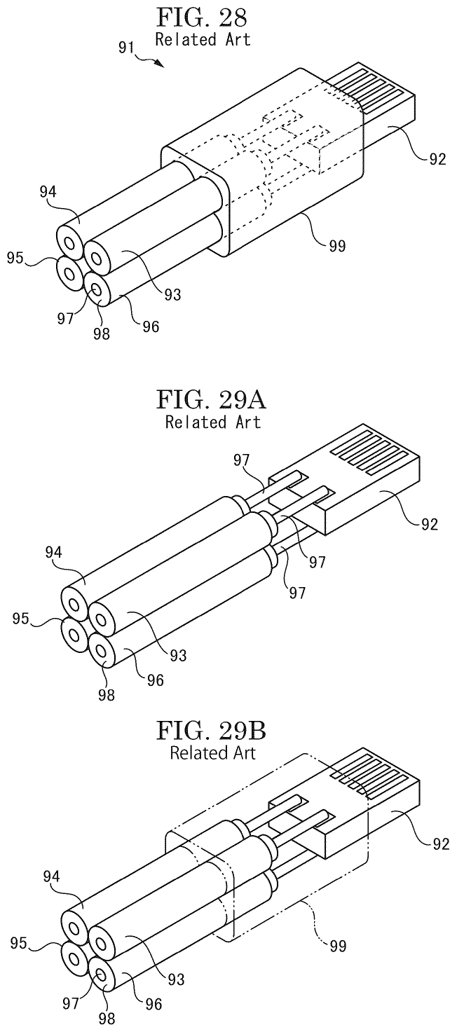

Further, in the connector device 1 of this embodiment, the outer profile of the cross section of the cover portion of each of the cables 21 to 24 is quadrilateral, and the portions on the back side of the exposed portions 35 in the front end portions of the cables 21 to 24 are arranged in parallel such that the upper surface 31, the lower surface 32, the left surface 33 or the right surface 34 of the cover portion 30 of one cable of the two adjacent cables in the cables 21 to 24 and the upper surface 31, the lower surface 32, the left surface 33 or the right surface 34 of the cover portion 30 of the other cable of the two adjacent cables in the cables 21 to 24 are in contact with each other, and the portions on the back side of the exposed portions 35 in the front end portions of the cables 21 to 24 are arranged such that there is no space by wholly or partially separating the respective cover portions 30 of the two adjacent cables in the cables 21 to 24 within the cross section of the whole of the portions of the cables 21 to 24. With this configuration, in manufacturing the connector device 1, when the back housing 41 is formed by overmolding, the molten resin can be prevented from flowing out to the outside of the mold 50, and the molding failure of the back housing 41 can be prevented. Specifically, a frequency of occurrence of molding failure of the back housing 41 in the connector device 1 of the present embodiment can be made lower than a frequency of occurrence of molding failure of the housing 99 in the connector device 91 as the comparative example shown in FIG. 28.

Further, in the connector device 1 of the present embodiment, the outer profile of the cross section of the whole of the cables 21 to 24 arranged in two rows in the upper-and-lower direction and in two rows in the left-and-right direction is a quadrilateral having four internal angles of 90 degrees, as shown in FIG. 6C. Therefore, the cross-sectional shape of the recess 53 of the first mold piece 51 is formed to be a quadrilateral having four internal angles of 90 degrees and the cross-sectional shape of the recess 56 of the second mold piece 52 is formed to be a quadrilateral having four internal angles of 90 degrees, so that when the cables 21 to 24 are arranged between the recess 53 and the recess 56 when the back housing 41 is molded, as shown in FIG. 12A, a space through which the molten resin can pass can be prevented from being formed between the outer circumferential surface of the whole of the cables 21 to 24 and the inner surface of the recess 53 and between the outer circumferential surface of the whole of the cables 21 to 24 and the inner surface of the recess 56. Therefore, according to the connector device 1 of the present embodiment, as compared with the connector device 91 as the comparative example shown in FIG. 28, the structure of the mold used for molding the back housing 41 can be simplified, the mold cost can be reduced, and the increase in the manufacturing cost of the connector device 1 can be suppressed.

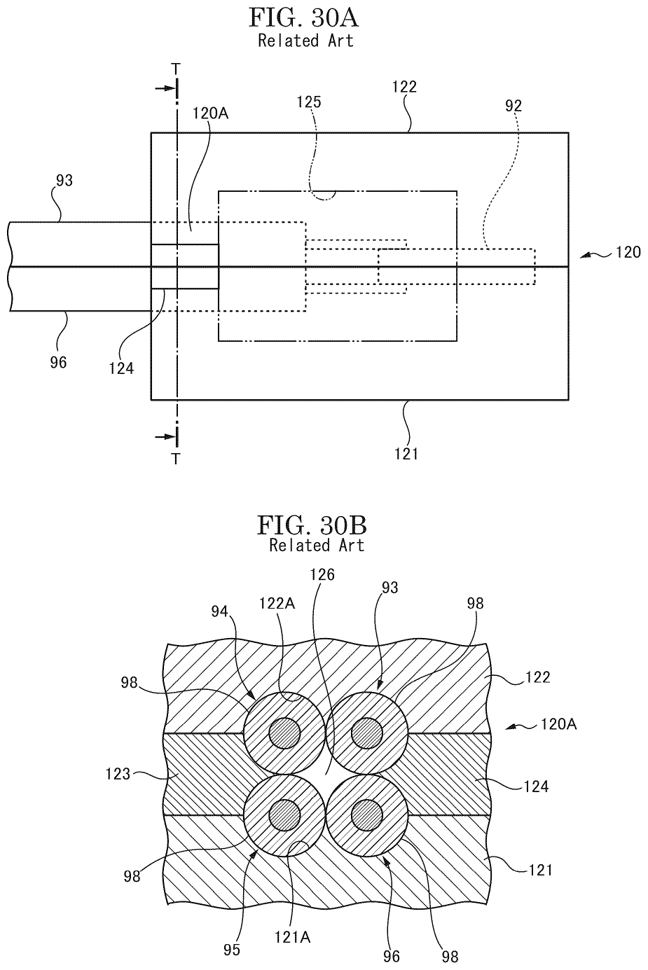

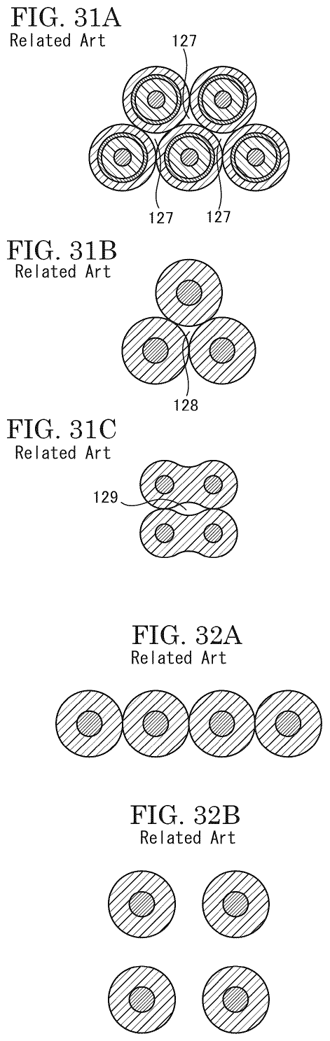

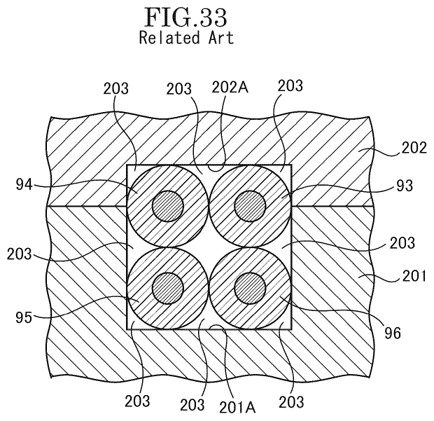

Specifically, in the connector device 91 as the comparative example shown in FIG. 28, the cables 93 to 96 each having the cover portion 98 of a cross section of a circular outer profile are arranged in two rows in the upper-and-lower direction and in two rows in the left-and-right direction. Suppose, as shown in FIG. 33, the cables 93 to 96 are arranged between a first mold piece 201 in which a recess 201A having a quadrilateral cross-sectional shape having four internal angles of 90 degrees is formed, and a second mold piece 202 in which a recess 202A having a quadrilateral cross-sectional shape having four internal angles of 90 degrees is formed. In this case, spaces 203 through which the molten resin can pass is formed between the cable 93 and the inner surface of the recess 202A, between the cable 93 and the inner surface of the recess 201A, between the cable 94 and the inner surface of the recess 202A, between the cable 94 and the inner surface of the recess 201A, between the cable 95 and the inner surface of the recess 201A, and between the cable 96 and the inner surface of the recess 201A. In the connector device 91 of the comparative example, in order to prevent the spaces 203 from being formed, as shown in FIG. 30B, the shape of the recess 121A of the first mold piece 121 is made to correspond to the shape of the lower portions of the respective cover portions 98 of the cables 95 and 96, the shape of the recess 122A of the second mold piece 122 is made to correspond to the shape of the upper portions of the respective cover portions 98 of the cables 93 and 94, and an insert (third mold piece 123) having a shape corresponding to the shape of the left portions of the respective cover portions 98 of the cables 94 and 95 is attached between the first mold piece 121 and the second mold piece 122, and an insert (fourth mold piece 30) having a shape corresponding to the shape of the right portions of the respective cover portions 98 of the cables 96 and 93 is attached between the first mold piece 121 and the second mold piece 122. In the connector device 1 of the present embodiment, as shown in FIG. 12A, it is possible to prevent the formation of the space through which the molten resin can pass between the outer circumferential surface of the whole of the cables 21 to 24 and the mold 50 without using an insert. However, in the connector device 91 of the comparative example, as shown in FIG. 30B, the insert is required to prevent the formation of the spaces through which the molten resin can pass between the outer circumferential surface of the whole of the cables 93 to 96 and the mold 120 (cable insertion part 120A). The connector device 1 of the present embodiment, which does not require the insert, can made the structure of the mold simpler than that of the connector device 91 of the comparative example requiring the insert, and the mold cost can be reduced.

Further, in the connector device 1 of the present embodiment, the outer profile of the cross section of the cover portion 30 of each of the cables 21 to 24 is a quadrilateral having four internal angles of 90 degrees. Therefore, as shown in FIG. 6C, by arranging the cables 21 to 24 in two rows in the upper-and-lower direction and in two rows in the left-and-right direction, the outer profile of the cross section of the whole of the cables 21 to 24 can be made to be a quadrilateral having four internal angles of 90 degrees, that is, the shape suitable for reducing the mold cost.

In the connector device of the present invention, the configuration of the connection part (connector part) is not limited to that described in the first embodiment. For example, as in the connector device 81 shown in FIG. 14, the connection part 82 may be a flat plate member provided with a contact 83 and a conductor portion 84. The housing 85 surrounds the portion from the back end portion of the connection part 82 to the front end portions of the cover portions of the cables 21 to 24, and is integrated with the portion by overmolding.

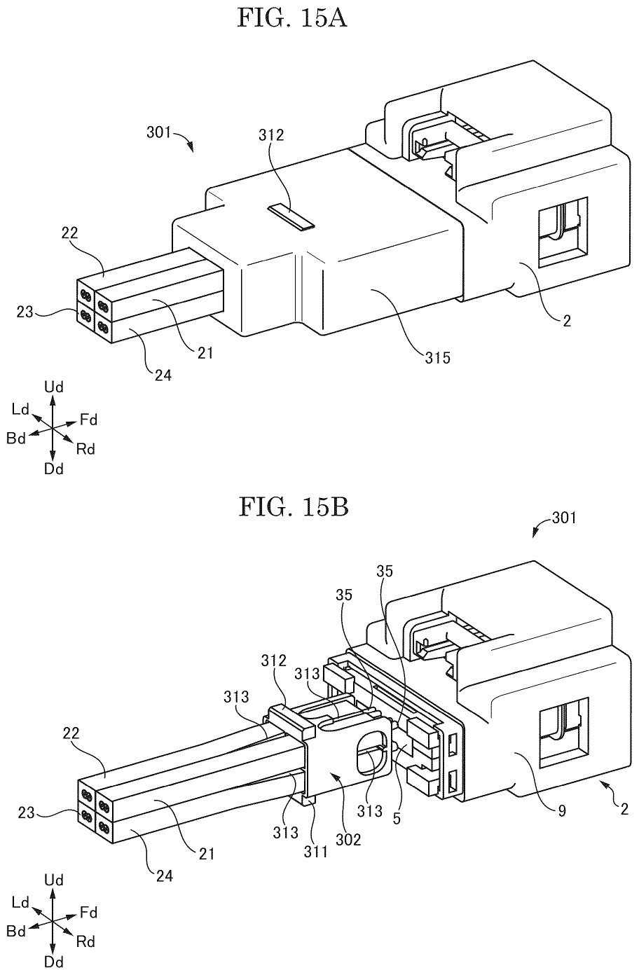

(Second Embodiment) Next, with reference to FIGS. 15 to 20, a connector device according to a second embodiment of the present invention will be described. In the connector device according to the second embodiment of the present invention, the same components as those in the connector device 1 according to the first embodiment of the present invention are shown by the same reference numerals, and the description thereof is omitted or simplified.

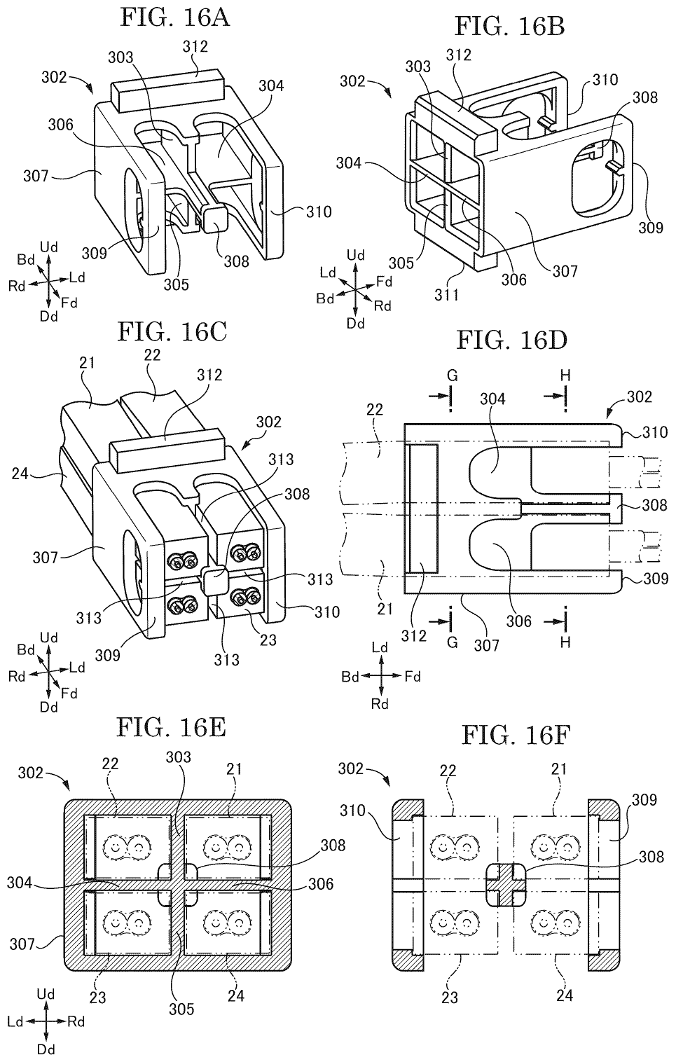

The connector device according to the second embodiment of the present invention has a characteristics in which, in the front end portions of the cables 21 to 24, the back portions of the portions surrounded by the back housing is arranged such that the flat portions (the upper surface 31, the lower surface 32, the left surface 33 or the right surface 34) of the outer circumferences of the respective cover portions 30 of the two adjacent cables in the cables 21 to 24 are in contact with each other and there is no space formed by separating the respective cover portions 30 of the two adjacent cables in the cables 21 to 24 within the cross section of the whole of the cables 21 to 24, and on the other hand, in the front end portions of the cables 21 to 24, the front portions of the portions surrounded by the back housing are arranged so as to form a spaced portion where the flat portions of the outer circumferences of the respective cover portions 30 of the two adjacent cables in the cables 21 to 24 face each other and are separated from each other.

[Connector Device] FIG. 15A shows a connector device 301 according to the second embodiment of the present invention as viewed from the oblique back side. FIG. 15B shows the connector device 301 without a back housing 315. As shown in FIGS. 15A and 15B, the connector device 301 includes the connector part 2, the cables 21 to 24, the back housing 315, and a cable position regulating member 302.

[Cable Position Regulating Member] FIG. 16A shows the cable position regulating member 302 as viewed from the oblique front side. FIG. 16B shows the cable position regulating member 302 as viewed from the oblique back side. FIG. 16C shows the cable position regulating member 302 attached to the front end portions of the cables 21 to 24. FIG. 16D shows the cable position regulating member 302, as viewed from the upper side. FIG. 16E shows the cross section of the cable position regulating member 302 taken along the line G-G in FIG. 16D, as viewed from the back side (the left side in FIG. 16D). FIG. 16F shows the cross section of the cable position regulating member 302 taken along the line H-H in FIG. 16D as viewed from the back side.

In the connector device 301, the cable position regulating member 302 is attached to the front end portions of the cables 21 to 24. The cable position regulating member 302 is a member which regulates the positions of the respective cover portions 30 of the two adjacent cables in the cables 21 to 24 to form the spaced portions 313 between the respective cover portions 30 of the two cables. The cable position regulating member 302 is made of, for example, resin or metal. As shown in FIGS. 16A and 16B, the cable position regulating member 302 has four insertion plate portions 303 to 306, a cover outer surface support portion 307, three cover end support portions 308 to 310, and two fixing portions 311 and 312.

As shown in FIG. 16B, the insertion plate portion 303 is formed in a plate shape extending in the front-and-back direction and the upper-and-lower direction, and is arranged at the upper portion of the back portion of the cable position regulating member 302. The insertion plate portion 304 is formed in a plate shape extending in the front-and-back direction and the left-and-right direction, and is arranged at the left portion of the back portion of the cable position regulating member 302. The insertion plate portion 305 is formed in a plate shape extending in the front-and-back direction and the upper-and-lower direction, and is arranged at the lower portion of the back portion of the cable position regulating member 302. The insertion plate portion 306 is formed in a plate shape extending in the front-and-back direction and the left-and-right direction, and is arranged at the right portion of the back portion of the cable position regulating member 302. When the cable position regulating member 302 is viewed from the back side, the insertion plate portions 303 to 306 are arranged in a cross shape as a whole, and the lower edge of the insertion plate portion 303, the right edge of the insertion plate portion 304, the upper edge of the insertion plate portion 305, and the left edge of the insertion plate portion 306 are coupled to each other.

When the cable position regulating member 302 is attached to the front end portions of the cables 21 to 24 as shown in FIG. 16C, the insertion plate portion 303 is inserted between the respective cover portions 30 of the cables 21 and 22 as shown in FIG. 16E. The insertion plate portion 304 is inserted between the respective cover portions 30 of the cables 22 and 23. The insertion plate portion 305 is inserted between the respective cover portions 30 of the cables 23 and 24. The insertion plate portion 306 is inserted between the respective cover portions 30 of the cables 24 and 21.

As shown in FIG. 16C, by inserting the insertion plate portion 303 between the respective cover portions 30 of the cables 21 and 22, the positions of the respective cover portions 30 of the cables 21 and 22 in the left-and-right direction are regulated, and the left surface 33 of the cover portion 30 of the cable 21 and the right surface 34 of the cover portion 30 of the cable 22 are separated from each other so that the spaced portion 313 is formed between them. Further, by inserting the insertion plate portion 304 between the respective cover portions 30 of the cables 22 and 23, the positions of the respective cover portions 30 of the cables 22 and 23 in the upper-and-lower direction are regulated, and the lower surface 32 of the cover portion 30 of the cable 22 and the upper surface 31 of the cover portion 30 of the cable 23 are separated from each other so that the spaced portion 313 is formed between them. By inserting the insertion plate portion 305 between the respective cover portions 30 of the cables 23 and 24, the positions of the respective cover portions 30 of the cables 23 and 24 in the left-and-right direction are regulated, and the right surface 34 of the cover portion 30 of the cable 23 and the left surface 33 of the cover portion 30 of the cable 24 are separated from each other so that the spaced portion 313 is formed between them. Further, by inserting the insertion plate portion 306 between the respective cover portions 30 of the cables 24 and 21, the positions of the respective cover portions 30 of the cables 24 and 21 in the upper-and-lower direction are regulated, and the upper surface 31 of the cover portion 30 of the cable 24 and the lower surface 32 of the cover portion 30 of the cable 21 are separated from each other so that the spaced portion 313 is formed between them.

As shown in FIG. 16B, the cover outer surface support portion 307 is formed in a quadrilateral pillar shape, and surrounds the entire outer circumference of the insertion plate portions 303 to 306 arranged in the cross shape. The cover outer surface support portion 307 is coupled to the upper edge of the insertion plate portion 303, the left edge of the insertion plate portion 304, the lower edge of the insertion plate portion 305, and the right edge of the insertion plate portion 306. When the cable position regulating member 302 is attached to the front end portions of the cables 21 to 24 as shown in FIG. 16C, the cover outer surface support portion 307 supports a surface facing outward in the outer circumferential surfaces of the cover portion 30 of each of the cables 21 to 24. The cover outer surface support portion 307 has a function of suppressing the displacement of each of the cables 21 to 24 due to the pressure of the resin injected into the mold 320 when molding the back housing 315.

As shown in FIGS. 16A and 16F, the cover end support portion 308 is arranged at the center of the front end portion of the cable position regulating member 302 in the left-and-right direction. The cover end support portion 308 is coupled to the respective front end portions of the lower portion of the insertion plate portion 303, the right portion of the insertion plate portion 304, the upper portion of the insertion plate portion 305, and the left portion of the insertion plate portion 306. The cover end support portion 309 is arranged at the right end portion of the front end portion of the cable position regulating member 302. The cover end support portion 309 is coupled to the right front edge portion of the cover outer surface support portion 307. The cover end support portion 310 is arranged at the left end portion of the front end portion of the cable position regulating member 302. The cover end support portion 310 is coupled to the left front edge portion of the cover outer surface support portion 307. As shown in FIG. 16C, when the cable position regulating member 302 is attached to the front end portions of the cables 21 to 24, the cover end support portion 308 supports the left lower corner of the front end of the cover portion 30 of the cable 21, the right lower corner of the front end of the cover portion 30 of the cable 22, the right upper corner of the front end of the cover portion 30 of the cable 23, and the left upper corner of the front end of the cover portion 30 of the cable 24. When the cable position regulating member 302 is attached to the front end portions of the cables 21 to 24, the cover end support portion 309 supports the right front edge portion of the cover portion 30 of the cable 21 and the right front edge portion of the cover portion 30 of the cable 24. When the cable position regulating member 302 is attached to the front end portions of the cables 21 to 24, the cover end support portion 310 supports the left front edge portion of the cover portion 30 of the cable 22 and the left front edge portion of the cover portion 30 of the cable 23. The cover end support portions 308 to 310 have a function of suppressing the displacement of each of the cables 21 to 24 due to the pressure of the resin injected into the mold 320 when the back housing 315 is molded.

As shown in FIG. 16B, the fixing portion 311 protrudes downward from the lower portion of the outer circumferential surface of the cover outer surface support portion 307. The fixing portion 312 protrudes upward from the upper portion of the outer circumferential surface of the cover outer surface support portion 307. The fixing portions 311 and 312 have a function of fixing the cable position regulating member 302 in the mold 320 and suppressing the displacement of the cable position regulating member 302 due to the pressure of the resin injected into the mold 320 when the back housing 315 is molded.

[Back Housing] As shown in FIG. 15A, the back housing 315 is provided at the back portion of the connector part 2. A material of the back housing 315 is the same as that of the back housing 41 of the first embodiment. The back housing 315 surrounds the back end portion of the connector part 2, the back end portions of the exposed portions 35 of the respective core portions 25 of the cables 21 to 24, the front end portions of the respective cover portions 30 of the cables 21 to 24, and the cable position regulating member 302 attached to the front end portions of the cables 21 to 24. The back housing 315 is a specific example of “housing”.

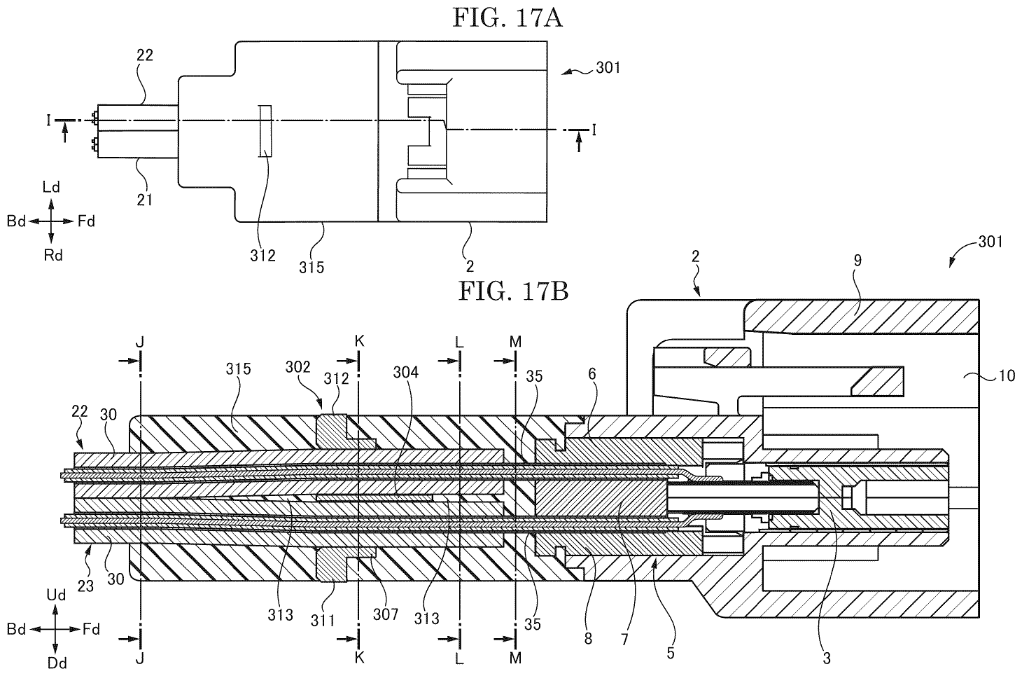

FIG. 17A shows the connector device 301 as viewed from the upper side. FIG. 17B shows a cross section of the connector device 301 taken along the line I-I in FIG. 17A as viewed from the right side (the lower side in FIG. 17A). As shown in FIG. 17B, the back housing 315 is a resin molded product formed by overmolding on the outer circumference of the back end portion of the connector part 2, the outer circumference of the back end portions of the exposed portions 35 of the respective core portions 25 of the cables 21 to 24, the outer circumference of the front end portions of the respective cover portions 30 of the cables 21 to 24, and the outer circumference of the cable position regulating member 302. The back housing 315 is integrated with the back end portion of the connector part 2, the back end portions of the exposed portions 35 of the respective core portions 25 of the cables 21 to 24, the front end portions of the respective cover portions 30 of the cables 21 to 24, and the cable position regulating member 302.

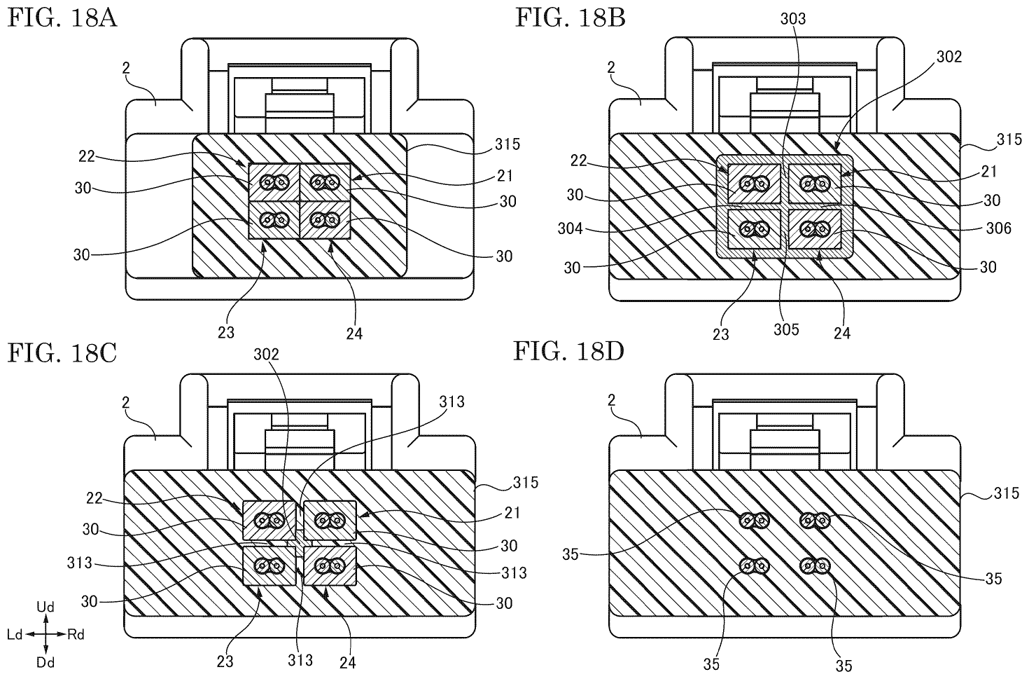

FIG. 18A shows a cross section of the connector device 301 taken along the line J-J in FIG. 17B as viewed from the back side (the left side in FIG. 17B). FIG. 18A shows a cross section of the back portions of the portions surrounded by the back housing 315, in the front end portions of the cables 21 to 24. As shown in FIG. 18A, in the front end portions of the cables 21 to 24, the entire circumference of the back portions of the portions surrounded by the back housing 315 are covered with the resin for forming the back housing 315. In the back portions of the portions surrounded by the back housing 315 in the front end portions of the cables 21 to 24, the resin for forming the back housing 315 is in close contact (more specifically, liquid-tightly contact) with the right surface 34 and the upper surface 31 of the cover portion 30 of the cable 21, the left surface 33 and the upper surface 31 of the cover portion 30 of the cable 22, the left surface 33 and the lower surface 32 of the cover portion 30 of the cable 23, and the right surface 34 and the lower surface 32 of the cover portion 30 of the cable 24 with an extremely high degree of adhesion. By such close contact between the cover portion 30 and the back housing 315, a liquid can be prevented from entering between the front end portions of the cover portions 30 of the cables 21 to 24 and the back housing 315, and the cables 21 to 24 can be firmly held by the back housing 315.

As shown in FIG. 18A, in the back portions of the portions surrounded by the back housing 315 in the front end portions of the cables 21 to 24, the flat surfaces of the cover portions 30 facing each other are brought in firm contact with each other over the entire areas. That is, the left surface 33 of the cover portion 30 of the cable 21 and the right surface 34 of the cover portion 30 of the cable 22, the lower surface 32 of the cover portion 30 of the cable 22 and the upper surface 31 of the cover portion 30 of the cable 23, the right surface 34 of the cover portion 30 of the cable 23 and the left surface 33 of the cover portion 30 of the cable 24, and the upper surface 31 of the cover portion 30 of the cable 24 and the lower surface 32 of the cover portion 30 of the cable 21 are brought in firm contact with each other over the entire areas. As a result, in the back portions of the portions surrounded by the back housing 315 in the front end portions of the cables 21 to 24, there is no space formed by separating the respective cover portions 30 of the two adjacent cables in the cables 21 to 24 from each other within the cross section of the whole of the cables 21 to 24. By such close contact between the flat surfaces of the cover portions 30 facing each other, it becomes possible to prevent a liquid from entering between the cover portions 30 of the cables 21 to 24.

FIG. 18B shows a cross section of the connector device 301 taken along the line K-K in FIG. 17B as viewed from the back side. FIG. 18B shows a cross section of the portions to which the cable position regulating member 302 is attached, in the front end portions of the cables 21 to 24. As shown in FIG. 18B, the portion of the cable position regulating member 302 excluding the fixing portions 311 and 312 is buried in the resin for forming the back housing 315 in the state where the insertion plate portions 303 to 306 are inserted between the cover portion 30 of the cable 21 and the cover portion 30 of the cable 22, between the cover portion 30 of the cable 22 and the cover portion 30 of the cable 23, between the cover portion 30 of the cable 23 and the cover portion 30 of the cable 24, and between the cover portion 30 of the cable 24 and the cover portion 30 of the cable 21. As shown in FIG. 17B, the portion of the fixing portion 311 excluding the lower end portion thereof is surrounded by the resin for forming the back housing 315. The lower end portion of the fixing portion 311 is exposed to the lower surface of the back housing 315. Similarly, the portion of the fixing portion 312 excluding the upper end portion thereof is surrounded by the resin for forming the back housing 315. The upper end portion of the fixing portion 312 is exposed to the upper surface of the back housing 315. The cable position regulating member 302 is thus covered with the resin for forming the back housing 315 so as be fixed to the back housing 315.

FIG. 18C shows a cross section of the connector device 301 taken along the line L-L in FIG. 17B as viewed from the back side. FIG. 18C shows a cross section of the front portions of the portions surrounded by the back housing 315 in the front end portions of the cables 21 to 24. As shown in FIG. 18C, in the front end portions of the cables 21 to 24, the front portions of the portions surrounded by the back housing 315 is arranged so as to form the spaced portions 313 where the flat portions of the outer circumferences of the respective cover portions 30 of the two adjacent cables in the cables 21 to 24 face each other and are separated from each other. In this embodiment, in the front end portions of the cables 21 to 24, the front portions of the portions surrounded by the back housing 315 are arranged such that the left surface 33 of the cover portion 30 of the cable 21 and the right surface 34 of the cover portion 30 of the cable 22 are separated from each other, the lower surface 32 of the cover portion 30 of the cable 22 and the upper surface 31 of the cover portion 30 of the cable 23 are separated from each other, the right surface 34 of the cover portion 30 of the cable 23 and the left surface 33 of the cover portion 30 of the cable 24 are separated from each other, and the upper surface 31 of the cover portion 30 of the cable 24 and the lower surface 32 of the cover portion 30 of the cable 21 are separated from each other. As a result, in the front portions of the portions surrounded by the back housing 315 in the front end portions of the cables 21 to 24, the spaced portions 313 are formed between the left surface 33 of the cover portion 30 of the cable 21 and the right surface 34 of the cover portion 30 of the cable 22, between the lower surface 32 of the cover portion 30 of the cable 22 and the upper surface 31 of the cover portion 30 of the cable 23, between the right surface 34 of the cover portion 30 of the cable 23 and the left surface 33 of the cover portion 30 of the cable 24, and between the upper surface 31 of the cover portion 30 of the cable 24 and the lower surface 32 of the cover portion 30 of the cable 21. The spaced portion 313 is a gap having a size enough to allow the molten resin to enter when the back housing 315 is molded.

Further, as shown in FIG. 18C, the resin for forming the back housing 315 enters each of the spaced portions 313. As a result, in the front portions of the portions surrounded by the back housing 315 in the front portions of the cables 21 to 24, the resin for forming the back housing 315 is in close contact (more specifically, liquid-tight contact) with all the outer circumferential surfaces, that is, the upper surface 31, the lower surface 32, the left surface 33, and the right surface 34, of the front end portion of the cover portion 30 of each of the cables 21 to 24, with an extremely high degree of adhesion. By such close contact between the cover portions 30 and the back housing 315, it is possible to prevent a liquid from entering between the front end portions of the cover portions 30 of the cables 21 to 24 and the back housing 315, and to firmly hold the cables 21 to 24 by the back housing 315.

FIG. 18D shows a cross section of the connector device 301 taken along the line M-M in FIG. 17B as viewed from the back side. FIG. 18D shows a cross section of the back end portions of the exposed portions 35 of the respective core portions 25 of the cables 21 to 24, that is, the portions exposed from the back end portion of the connector part 2 to the outside of the connector part 2 in the exposed portions 35 of the respective core portions 25 of the cables 21 to 24. As shown in FIG. 18D, the entire outer circumference of the back end portion of the exposed portion 35 of the core portion 25 of each of the cables 21 to 24 is covered with the resin for forming the back housing 315, and the entire outer circumferential surface of the back end portion of the exposed portion 35 of the core portion 25 of each of the cables 21 to 24 is in close contact (more specifically, liquid-tight contact) with the resin for forming the back housing 315 with an extremely high degree of adhesion. By such close contact between the exposed portion 35 of the core portion 25 and the back housing 315, it becomes possible to prevent a liquid from entering between the back end portion of the exposed portion 35 of the core portion 25 of each of the cables 21 to 24 and the back housing 315, and to firmly hold the back end portion of the exposed portion 35 of the core portion 25 of each of the cables 21 to 24 by the back housing 315.

As shown in FIGS. 15A and 17B, the back end portion of the connector part 2 is covered with the resin for forming the back housing 315, and the resin is into close contact with the portions. By such contact between the back end portion of the connector part 2 and the back housing 315, it is possible to prevent a liquid from entering between the back end portion of the connector part 2 and the back housing 315.

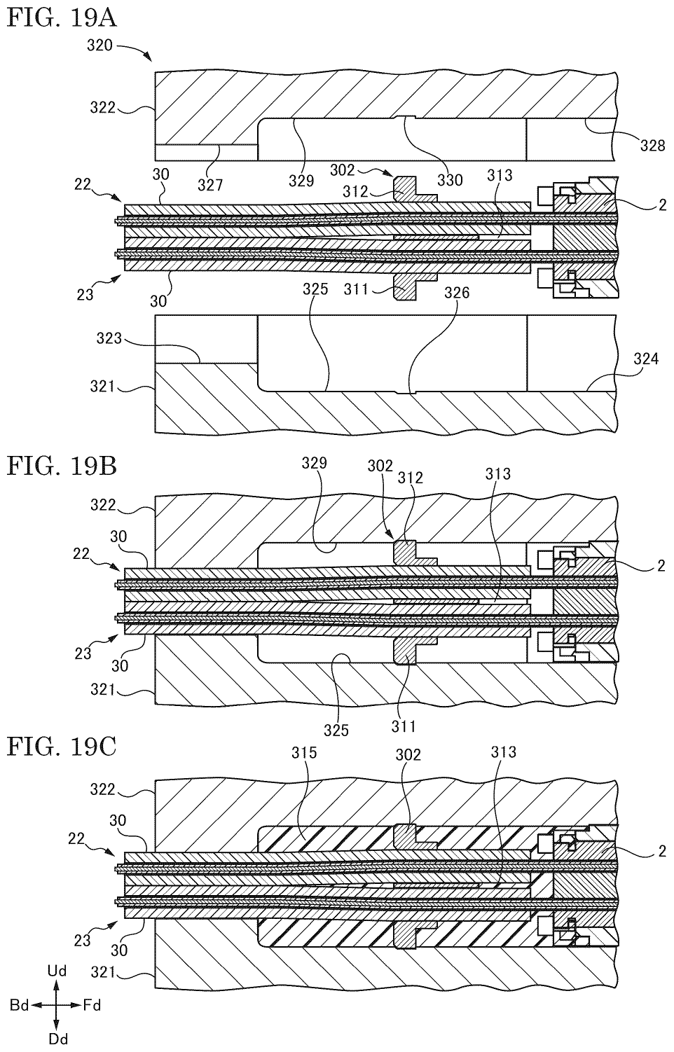

As shown in FIG. 17B, in the back end portion of the connector part 2, a first liquid stopping structure is formed by the close contact between the outer circumferential surface of the whole of the cover portions 30 of the cables 21 to 24 and the back housing 315 and the close contact between flat portions of the cover portions 30 facing each other. In the front portion of the back housing 315, a second liquid stopping structure is formed by the close contact between the outer circumferential surface of the whole of the individual cover portions 30 separated from each other of the cables 21 to 24. In the front end portion of the back housing 315, a third liquid stopping structure is formed by the close contact between the exposed portion 35 of the core portion 25 and the back housing 315. These three liquid stopping structures can reliably prevent a liquid from entering the connector part 2 from the back end of the back housing 315 through the inside of the back housing 315. For example, if a liquid may enter between the cover portions 30 due to a capillary phenomenon (even if the liquid passes through the first liquid stopping structure), the flowing of the liquid within the back housing 315 toward the connector part 2 is reliably prevented by the second or third liquid stopping structure. Therefore, the liquid does not reach the connector part 2.

[Method of Manufacturing Connector Device] FIGS. 19A, 19B and 19C show a method of manufacturing the connector device 301. In manufacturing the connector device 301, first, the distal end portion of the front end portion of the cover portion 30 of each of the cables 21 to 24 is cut off to form the exposed portion 35 (an exposed portion formation step). Next, the cable position regulating member 302 is attached to the front end portions of the cables 21 to 24 (a cable position regulating member attachment step). Next, the cables 21 to 24 are attached to the connector part 2 (a cable attachment step). Next, the connector part 2, the cables 21 to 24, and the cable position regulating member 302 attached to the front end portions of the cables 21 to 24 are arranged in a mold 320 for forming the back housing 315, and the front end portions of the cables 21 to 24 are arranged (a cable arrangement step). Then, the molten resin is injected into the mold 320 to form the back housing 315 (a housing formation step).

In FIG. 19A, the mold 320 for forming the back housing 315 includes a first mold piece 321 and a second mold piece 322. For example, the second mold piece 322 is movable upward and downward relative to the first mold piece 321. The first mold piece 321 has a recess 323 (groove) for arranging the cable 23, the cable 24, the lower portion of the cable 21, and the lower portion of the cable 22. The first mold piece 321 has a recess 324 for arranging the lower portion of the connector part 2. The first mold piece 321 has a cavity 325 for filling the resin to form the back housing 315. On the bottom surface of the cavity 325, a recess 326 for fixing the cable position regulating member 302 is formed. The second mold piece 322 has a recess 327 (groove) for arranging the upper portion of the cable 21 and the upper portion of the cable 22. The second mold piece 322 has a recess 328 for arranging the upper portion of the connector part 2. The second mold piece 322 has a cavity 329 for filling the resin to form the back housing 315. On the ceiling surface of the cavity 329, a recess 330 for fixing the cable position regulating member 302 is formed. The shape and size of each of the recess 323 of the first mold piece 321 and the recess 327 of the second mold piece 322 in the mold 320 are the same as the shape and size of the recess 53 of the first mold piece 51 and the recess 56 of the second mold piece 52 in the mold 50 of the first embodiment.

In forming the back housing 315, the connector part 2, the cables 21 to 24, and the cable position regulating member 302 attached to the front end portions of the cables 21 to 24 are arranged between the first mold piece 321 and the second mold piece 322 as shown in FIG. 19B. At this time, for example, the lower portion of the connector part 2 is inserted into the recess 324 of the first mold piece 321, the lower portion of the cable position regulating member 302 attached to the front end portions of the cables 21 to 24 is inserted into the cavity 325 of the first mold piece 321, the lower end portion of the fixing portion 311 of the cable position regulating member 302 is inserted into the recess 326 of the first mold piece 321, the cables 23 and 24 are inserted into the recess 323 of the first mold piece 321, and the lower portion of the cable 21 and the lower portion of the cable 22 are inserted into the recess 323 of the first mold piece 321. Next, when the second mold piece 322 is attached to the first mold piece 321, the upper portion of the connector part 2 is inserted into the recess 328 of the second mold piece 322, the upper portion of the cable position regulating member 302 attached to the front end portions of the cables 21 to 24 is inserted into the cavity 329 of the second mold piece 322, the upper end portion of the fixing portion 312 of the cable position regulating member 302 is inserted into the recess 330 of the first mold piece 321, and the upper portion of the cable 21 and the upper portion of the cable 22 are inserted into the recess 327 of the second mold piece 322.

In the state where the connector part 2, the cables 21 to 24, and the cable position regulating member 302 attached to the front end portions of the cables 21 to 24 are thus arranged in the mold 320, the front portions of the portions surrounded by the back housing 315 in the front end portions of the cables 21 to 24 are arranged in the front portions of the cavities 325 and 329 of the mold 320. The front portions of the portions surrounded by the back housing 315 in the front end portions of the cables 21 to 24 have the spaced portions 313 formed by the cable position regulating member 302. The back portions of the portions surrounded by the back housing 315 in the front end portions of the cables 21 to 24 are arranged in the back portions of the cavities 325 and 329 of the mold 320. The portions immediately behind the portions surrounded by the back housing 315 in the cables 21 to 24 are arranged between the recess 323 and the recess 327 of the mold 320. By arranging the portions immediately behind the portions surrounded by the back housing 315 in the cables 21 to 24 between the recesses 323 and 327 of the mold 320, the portions immediately behind the portions surrounded by the back housing 315 in the cables 21 to 24 are arranged such that the flat portions of the outer circumferences of the respective cover portions 30 of the two adjacent cables in the cables 21 to 24 are in contact with each other and no space is formed by separating the respective cover portions 30 of the two adjacent cables in the cables 21 to 24 from each other within the cross section of the whole of the cables 21 to 24. Therefore, the back portions of the portions surrounded by the back housing 315 in the cables 21 to 24 are displaced such that the respective cover portions 30 of the two adjacent cables in the cables 21 to 24 are brought into contact with each other, and the back portions of the portions surrounded by the back housing 315 in the cables 21 to 24 are in a state where the spaced portion 313 is not present. As a result, the back portions of the portions surrounded by the back housing 315 in the cables 21 to 24 are arranged such that the flat portions of the outer circumferences of the respective cover portions 30 of the two adjacent cables in the cables 21 to 24 are in contact with each other and there is no space formed by separating the respective cover portions 30 of the two adjacent cables in the cables 21 to 24 from each other within the cross section of the whole of the cables 21 to 24.

Then, as shown in FIG. 19C, the molten resin is injected into the cavities 325 and 329 of the mold 320. Thus, the back end portion of the connector part 2, the back end portions of the exposed portions 35 of the respective core portions 25 of the cables 21 to 24, the front end portions of the respective cover portions 30 of the cables 21 to 24, and the cable position regulating member 302 attached to the front end portions of the cables 21 to 24 are covered with the resin. Further, the resin enters the spaced portions 313 of the cables 21 to 24.

The back end portions of the cavities 325 and 329 of the mold 320 are closed since the portions immediately behind the portions surrounded by the back housing 315 in the front end portions of the cables 21 to 24 are arranged in between the recess 323 of the first mold piece 321 and the recess 327 of the second mold piece 322. The front end portions of the cavities 325 and 329 of the mold 320 are closed since the connector part 2 is arranged between the recess 324 of the first mold piece 321 and the recess 328 of the second mold piece 322. As a result, when the molten resin is injected into the cavities 325 and 329 of the mold 320, the resin does not flow out of the mold 320. Therefore, the pressure of the resin in the mold 320 can be sufficiently increased. Accordingly, in the molding of the back housing 315, it is possible to suppress the occurrence of molding failure such as short molding.

After the resin injected into the mold 320 is solidified, the connector device 301 in which the back housing 315 is formed is separated from the mold 320. This completes the connector device 301.

The connector device 301 according to the second embodiment of the present invention having the above-described configuration exhibits the same or similar effect as the connector device 1 according to the first embodiment of the present invention. Further, in the connector device 301 according to the second embodiment of the present invention, the cable position regulating member 302 is attached to the front end portions of the cables 21 to 24, and the cable position regulating member 302 forms the spaced portions 313 in the front portions of the portions surrounded by the back housing 315 in the front end portions of the cables 21 to 24, and the resin for forming the back housing 315 enters the spaced portions 313. As a result, in the front end portions of the portions surrounded by the back housing 315 in the front end portions of the cables 21 to 24, the resin for forming the back housing 315 is in contact with all the outer circumferential surfaces of the respective cover portions 30 of the cables 21 to 24 with an extremely high degree of adhesion. With this configuration, according to the connector device 301 of the second embodiment of the present invention, as compared with the connector device 1 of the first embodiment of the present invention, the liquid stopping performance of the back housing 315 can be enhanced, and it becomes possible to surely prevent a liquid from entering the connector part 2. According to the connector device 301 of the second embodiment of the present invention, as compared with the connector device 1 of the first embodiment of the present invention, it becomes possible to increase the strength to hold the cables 21 to 24 in the connector device 301.

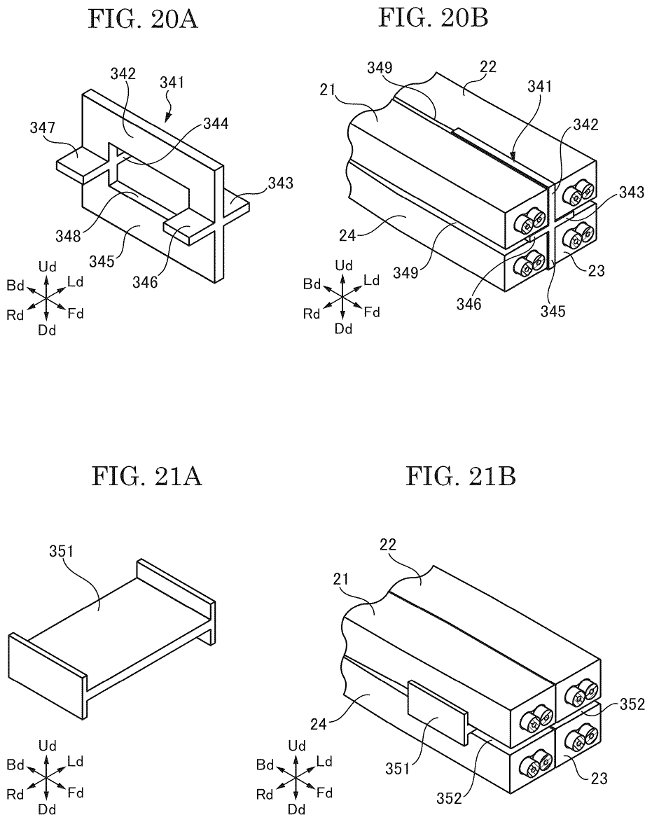

The cable position regulating member according to the present invention is not limited to the above-described cable position regulating member 302, but may use a cable position regulating member having other shapes as shown in FIG. 20A or FIG. 21A, for example. The cable position regulating member 341 shown in FIG. 20A has insertion plate portions 342 to 347. A hole 348 is provided in the center of the cable position regulating member 341. As shown in FIG. 20B, when the cable position regulating member 341 is attached to the front end portions of the cables 21 to 24, the insertion plate portion 342 is inserted between the cover portion 30 of the cable 21 and the cover portion 30 of the cable 22, the insertion plate portions 343 and 344 are inserted between the cover portion 30 of the cable 22 and the cover portion 30 of the cable 23, the insertion plate portion 345 is inserted between the cover portion 30 of the cable 23 and the cover portion 30 of the cable 24, and the insertion plate portions 346 and 347 are inserted between the cover portion 30 of the cable 24 and the cover portion 30 of the cable 21. When the cable position regulating member 341 is attached to the front end portions of the cables 21 to 24, the hole 348 is arranged in a portion where the left lower edge portion of the cover portion 30 of the cable 21, the right lower edge portion of the cover portion 30 of the cable 22, the right upper edge portion of the cover portion 30 of the cable 23, and the left upper edge portion of the cover portion 30 of the cable 24 face each other. Thus, the spaced portions 349 are formed between the cover portion 30 of the cable 21 and the cover portion 30 of the cable 22, between the cover portion 30 of the cable 22 and the cover portion 30 of the cable 23, between the cover portion 30 of the cable 23 and the cover portion 30 of the cable 24, and between the cover portion 30 of the cable 24 and the cover portion 30 of the cable 21. Further, the spaced portion is formed at a portion where the left lower edge portion of the cover portion 30 of the cable 21, the right lower edge portion of the cover portion 30 of the cable 22, the right upper edge portion of the cover portion 30 of the cable 23, and the left upper edge portion of the cover portion 30 of the cable 24 face each other. When the back housing is formed, the resin for forming the back housing enters the spaced portion 349 and the spaced portion formed by the hole 348. The cable position regulating member 351 shown in FIG. 21A is formed in a plate shape. As shown in FIG. 21B, the cable position regulating member 351 is inserted between the respective cover portions 30 of the cables 21 and 22 and the respective cover portions 30 of the cables 23 and 24. Thus, the spaced portions 352 are formed between the respective cover portions 30 of the cables 21 and 22 and the respective cover portions 30 of the cables 23 and 24. When the back housing is formed, the resin for forming the back housing enters the spaced portions 352.

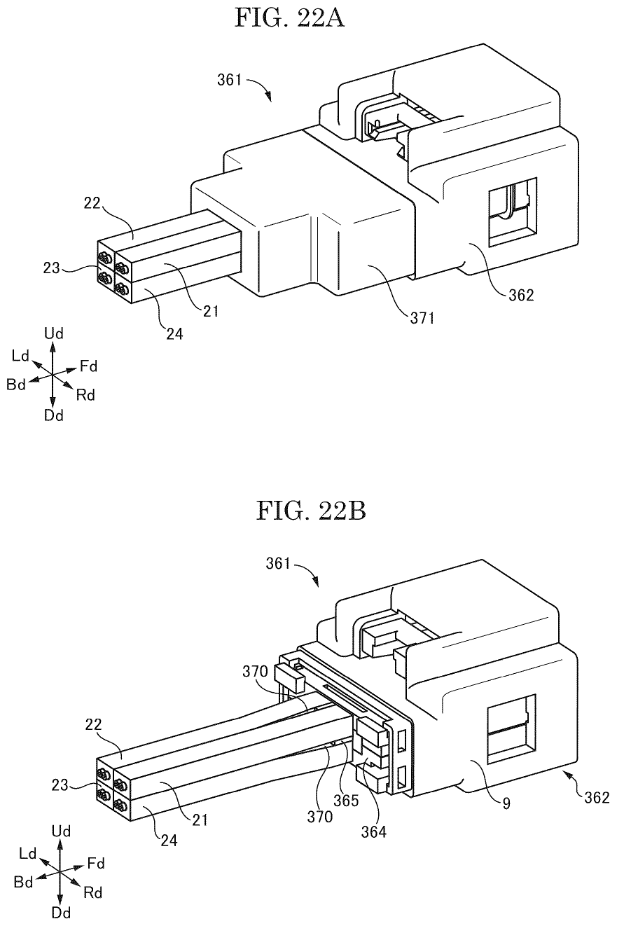

(Third Embodiment) Next, with reference to FIGS. 22 to 25, a connector device according to a third embodiment of the present invention will be described. In the connector device according to the third embodiment of the present invention, the same components as those in the connector device 1 according to the first embodiment of the present invention are denoted by the same reference numerals, and the description thereof is omitted or simplified.

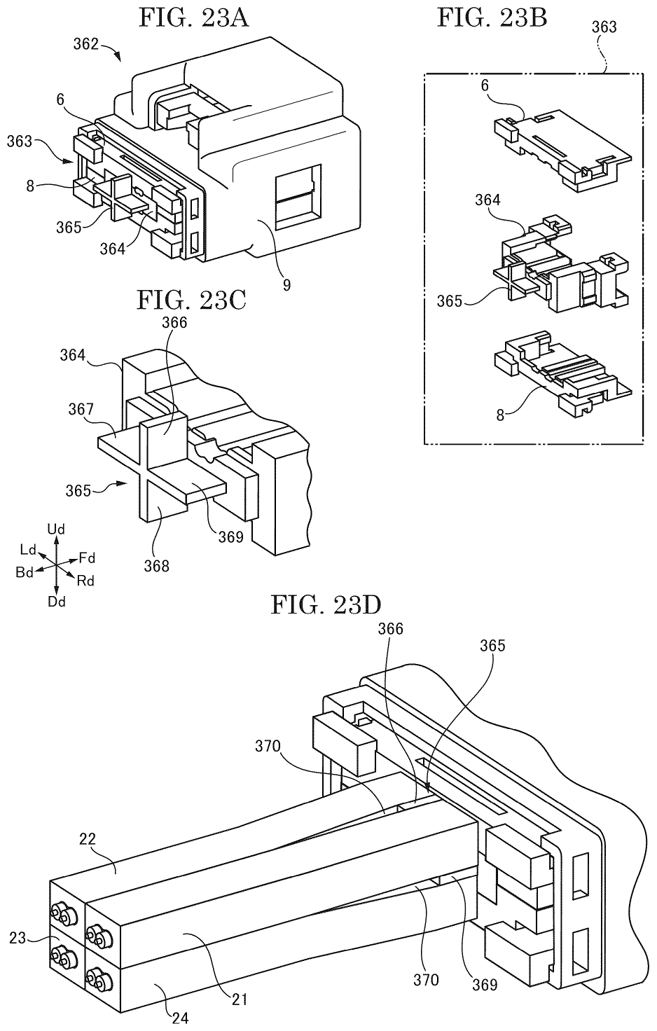

A characteristic of the connector device according to the third embodiment of the present invention is that the cable position regulating part forming the spaced portions of the cables 21 to 24 is provided in the connector part.

[Connector Device] FIG. 22A shows a connector device 361 according to the third embodiment of the present invention as viewed from oblique back side. FIG. 22B shows the connector device 361 without the back housing 371. As shown in FIGS. 22A and 22B, the connector device 361 includes the connector part 362, the cables 21 to 24, and the back housing 371.

[Connector Part] FIG. 23A shows a state in which the connector part 362 is assembled without attaching the cables 21 to 24 to the connector part 362. FIG. 23B is an exploded view showing the cover 363 in the connector part 362. FIG. 23C shows the cable position regulating part 365 in the intermediate cover member 364 of the cover 363. FIG. 23D shows the back portion of the connector part 362 to which the cables 21 to 24 are attached.

As shown in FIG. 23A, the connector part 362 includes the body part 3, the cover 363, and the connector housing 9 (see FIG. 5 for the body part 3). As shown in FIG. 23B, the cover 363 includes the upper cover member 6, an intermediate cover member 364, and the lower cover member 8. The connector part 362 is a specific example of “connection part”.

In the same manner as the cover 5 in the first embodiment, the cover 363 has a function of closing the back end portion of the connector part 362, specifically, the back opening of the connector housing 9, while holding the core portions 25 (the exposed portions 35) exposed from the front end portions of the cover portions 30 of the cables 21 to 24.

In the same manner as the upper cover member 6 and the lower cover member 8, the intermediate cover member 364 is made of insulative material such as resin. The upper cover member 6 is assembled to the upper portion of the intermediate cover member 364, and the lower cover member 8 is assembled to the lower portion of the intermediate cover member 364. The core portions 25 (the exposed portions 35) exposed from the front end portions of the respective cover portions 30 of the cables 21 and 22 are held between the intermediate cover member 364 and the upper cover member 6. The core portions 25 (the exposed portions 35) exposed from the front end portions of the respective cover portions 30 of the cables 23 and 24 are held between the intermediate cover member 364 and the lower cover member 8.

As shown in FIG. 23C, the intermediate cover member 364 is provided with a cable position regulating part 365. The cable position regulating part 365 has a function of regulating the positions of the respective cover portions 30 of the two adjacent cables in the cables 21 to 24 to form the spaced portion 370 between the respective cover portions 30 of the two cables. In the connector device 301 according to the second embodiment, the cable position regulating member 302 provided independently from the other members is attached to the front end portions of the cables 21 to 24, while in the connector device 361 according to the third embodiment, the cable position regulating member is coupled to the intermediate cover member 364 of the cover 363 of the connector part 362. That is, the cable position regulating part 365 is one that the cable position regulating member is coupled to the intermediate cover member 364. In this embodiment, the cable position regulating part 365 is integrally formed with the intermediate cover member 364.

The cable position regulating part 365 has four insertion plate portions 366 to 369. The insertion plate portion 366 is formed in a plate shape extending in the front-and-back direction and the upper-and-lower direction, and protrudes backward from the upper portion of the back surface of the intermediate cover member 364. The insertion plate portion 367 is formed in a plate shape extending in the front-and-back direction and the left-and-right direction, and protrudes backward from the left portion of the back surface of the intermediate cover member 364. The insertion plate portion 368 is formed in a plate shape extending in the front-and-back direction and the upper-and-lower direction, and protrudes backward from the lower portion of the back surface of the intermediate cover member 364. The insertion plate portion 369 is formed in a plate shape extending in the front-and-back direction and the left-and-right direction, and protrudes backward from the right portion of the back surface of the intermediate cover member 364. When the intermediate cover member 364 is viewed from the back side, the insertion plate portions 366 to 369 are arranged in a cross shape as a whole, and the lower edge of the insertion plate portion 366, the right edge of the insertion plate portion 367, the upper edge of the insertion plate portion 368, and the left edge of the insertion plate portion 369 are coupled to each other.

When the cables 21 to 24 are attached to the connector part 362 as shown in FIG. 23D, the insertion plate portion 366 is inserted between the respective cover portions 30 of the cables 21 and 22. The insertion plate portion 367 is inserted between the respective cover portions 30 of the cables 22 and 23. The insertion plate portion 368 is inserted between the respective cover portions 30 of the cables 23 and 24. The insertion plate portion 369 is inserted between the respective cover portions 30 of the cables 24 and 21.

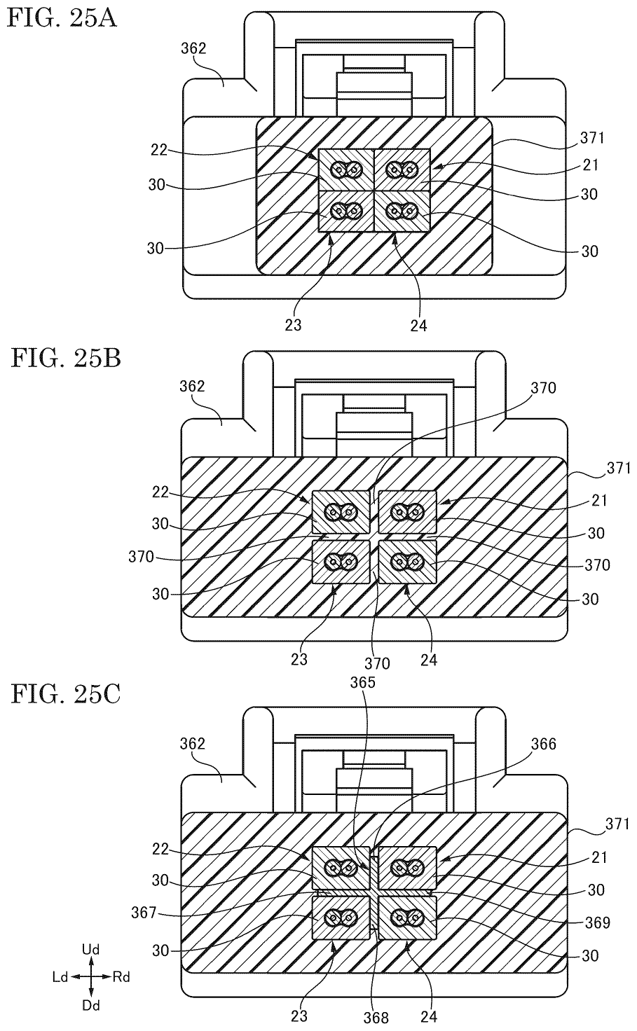

By inserting the insertion plate portion 366 between the respective cover portions 30 of the cables 21 and 22, the positions of the respective cover portions 30 of the cables 21 and 22 in the left-and-right direction are regulated, the left surface 33 of the cover portion 30 of the cable 21 and the right surface 34 of the cover portion 30 of the cable 22 are separated from each other so that the spaced portion 370 is formed between them. Further, by inserting the insertion plate portion 367 between the respective cover portions 30 of the cables 22 and 23, the positions of the respective cover portions 30 of the cables 22 and 23 in the upper-and-lower direction are regulated, the lower surface 32 of the cover portion 30 of the cable 22 and the upper surface 31 of the cover portion 30 of the cable 23 are separated from each other so that the spaced portion 370 is formed between them (see FIG. 25B). Further, by inserting the insertion plate portion 368 between the respective cover portions 30 of the cables 23 and 24, the positions of the respective cover portions 30 of the cables 23 and 24 in the left-and-right direction are regulated, the right surface 34 of the cover portion 30 of the cable 23 and the left surface 33 of the cover portion 30 of the cable 24 are separated from each other so that the spaced portion 370 is formed between them (see FIG. 25B). Further, by inserting the insertion plate portion 369 between the respective cover portions 30 of the cables 24 and 21, the positions of the respective cover portions 30 of the cables 24 and 21 in the upper-and-lower direction are regulated, the upper surface 31 of the cover portion 30 of the cable 24 and the lower surface 32 of the cover portion 30 of the cable 21 are separated from each other so that the spaced portion 370 is formed between them.

[Back housing] As shown in FIG. 22A, the back housing 371 is provided at the back portion of the connector part 362. The material of the back housing 371 is the same as that of the back housing 41 of the first embodiment. The back housing 371 surrounds the back end portion of the connector part 362 and the front end portions of the respective cover portions 30 of the cables 21 to 24. The back housing 371 is a specific example of “housing”.

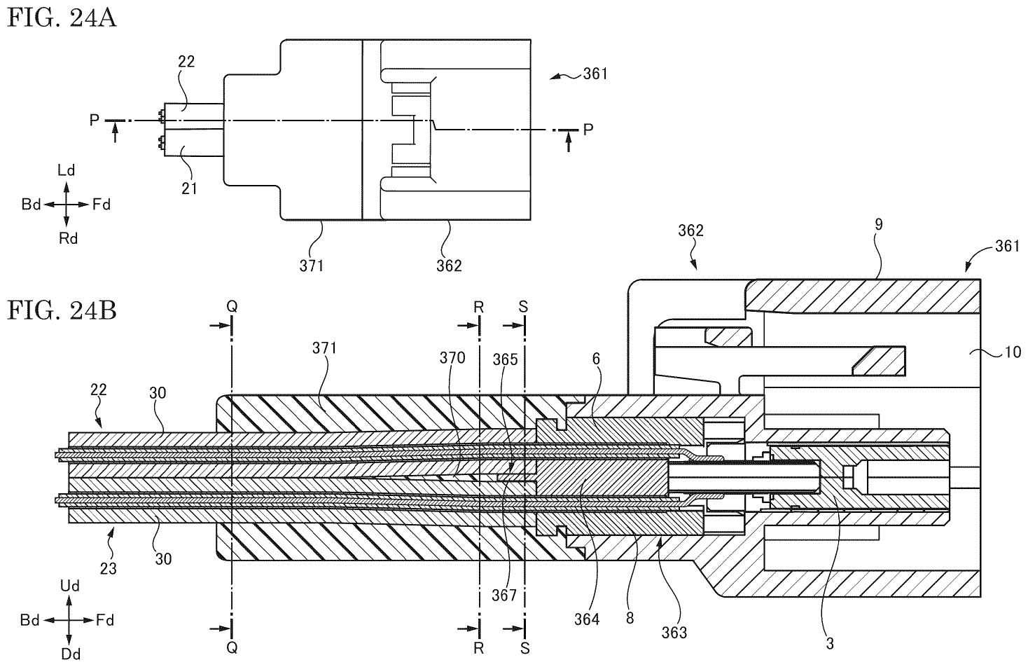

FIG. 24A shows the connector device 361 as viewed from the upper side. FIG. 24B shows a cross section of the connector device 361 taken along the line P-P in FIG. 24A as viewed from the right side (the lower side in FIG. 24A). As shown in FIG. 24B, the back housing 371 is formed by overmolding on the outer circumference of the back end portion of the connector part 2 and on the outer circumferences of the front end portions of the respective cover portions 30 of the cables 21 to 24, and is integrated with the back end portion of the connector part 2 and the front end portions of the respective cover portions 30 of the cables 21 to 24.

FIG. 25A shows a cross section of the connector device 361 taken along the line Q-Q in FIG. 24B as viewed from the back side (the right side in FIG. 24B). FIG. 25A shows a cross section of the back portions of the portions surrounded by the back housing 371 in the front end portions of the cables 21 to 24. As shown in FIG. 25A, the entire circumference of the back portions of the portions surrounded by the back housing 371 in the front end portions of the cables 21 to 24 are covered with the resin for forming the back housing 371. In the back portions of the portions surrounded by the back housing 371 in the front end portions of the cables 21 to 24, the resin for forming the back housing 371 is in close contact (more specifically, liquid-tightly contact) with the right surface 34 and the upper surface 31 of the cover portion 30 of the cable 21, the left surface 33 and the upper surface 31 of the cover portion 30 of the cable 22, the left surface 33 and the lower surface 32 of the cover portion 30 of the cable 23, and the right surface 34 and the lower surface 32 of the cover portion 30 of the cable 24 with an extremely high degree of adhesion. By such close contact between the cover portions 30 and the back housing 371, it is possible to prevent a liquid from entering between the front end portions of the cover portions 30 of the cables 21 to 24 and the back housing 371, and to firmly hold the cables 21 to 24 by the back housing 371.

As shown in FIG. 25A, in the back portions of the portions surrounded by the back housing 371 in the front end portions of the cables 21 to 24, the flat surfaces of the cover portions 30 facing each other are in close contact with each other over the entire areas. That is, the left surface 33 of the cover portion 30 of the cable 21 and the right surface 34 of the cover portion 30 of the cable 22, the lower surface 32 of the cover portion 30 of the cable 22 and the upper surface 31 of the cover portion 30 of the cable 23, the right surface 34 of the cover portion 30 of the cable 23 and the left surface 33 of the cover portion 30 of the cable 24, and the upper surface 31 of the cover portion 30 of the cable 24 and the lower surface 32 of the cover portion 30 of the cable 21 are in firm contact with each other over the entire areas. As a result, in the back portions of the portions surrounded by the back housing 371 in the front end portions of the cables 21 to 24, there is no space formed by separating the respective cover portions 30 of the two adjacent cables in the cables 21 to 24 from each other within the cross section of the whole of the cables 21 to 24. By such close contact between the flat surfaces of the cover portions 30 facing each other, it is possible to prevent a liquid from entering between the cover portions 30 of the cables 21 to 24.

FIG. 25B shows a cross section of the connector device 361 taken along the line R-R in FIG. 24B as viewed from the back side (the right side in FIG. 24B). FIG. 25B shows a cross section of the front portions of the portions surrounded by the back housing 371 in the front end portions of the cables 21 to 24. As shown in FIG. 25B, in the front end portions of the cables 21 to 24, the front portions of the portions surrounded by the back housing 371 are arranged so as to form the spaced portion 370 where the flat portions of the outer circumferences of the respective cover portions 30 of the two adjacent cables in the cables 21 to 24 face each other and are separated from each other. In this embodiment, the front portions of the portions surrounded by the back housing 371 in the front end portions of the cables 21 to 24 are arranged such that the left surface 33 of the cover portion 30 of the cable 21 and the right surface 34 of the cover portion 30 of the cable 22 are separated from each other, the lower surface 32 of the cover portion 30 of the cable 22 and the upper surface 31 of the cover portion 30 of the cable 23 are separated from each other, the right surface 34 of the cover portion 30 of the cable 23 and the left surface 33 of the cover portion 30 of the cable 24 are separated from each other, and the upper surface 31 of the cover portion 30 of the cable 24 and the lower surface 32 of the cover portion 30 of the cable 21 are separated from each other. As a result, in the front portions of the portions surrounded by the back housing 371 in the front end portions of the cables 21 to 24, the spaced portions 370 are formed between the left surface 33 of the cover portion 30 of the cable 21 and the right surface 34 of the cover portion 30 of the cable 22, between the lower surface 32 of the cover portion 30 of the cable 22 and the upper surface 31 of the cover portion 30 of the cable 23, between the right surface 34 of the cover portion 30 of the cable 23 and the left surface 33 of the cover portion 30 of the cable 24, and between the upper surface 31 of the cover portion 30 of the cable 24 and the lower surface 32 of the cover portion 30 of the cable 21. The spaced portion 370 is a gap having a size enough to allow the molten resin to enter when the back housing 371 is molded.

Further, as shown in FIG. 25B, the resin for forming the back housing 315 enters the respective spaced portions 370. As a result, in the front portions of the portions surrounded by the back housing 371 in the front end portions of the cables 21 to 24, the resin for forming the back housing 371 is in close contact (more specifically, liquid-tight contact) with all the outer circumferential surfaces, that is, the upper surface 31, the lower surface 32, the left surface 33, and the right surface 34, of the front end portions of the respective cover portions 30 of the cables 21 to 24, with an extremely high degree of adhesion. By such close contact between the cover portions 30 and the back housing 371, it is possible to prevent a liquid from entering between the front end portions of the cover portions 30 of the cables 21 to 24 and the back housing 371, and to firmly hold the cables 21 to 24 by the back housing 371.

FIG. 25C shows a cross section of the connector device 361 taken along the line S-S in FIG. 24B as viewed from the back side (the right side in FIG. 24B). FIG. 25C shows a cross section of the insertion plate portions 366 to 369 of the cable position regulating part 365 inserted between the cover portions 30 of the cables 21 to 24.

As shown in FIG. 24B, in the back portion of the back housing 371, a first liquid stopping structure is formed by the close contact between the outer circumferential surface of the whole of the cover portions 30 of the cables 21 to 24 and the back housing 371 and the close contact between the flat surfaces of the cover portions 30 facing each other. In the front portion of the back housing 371, a second liquid stopping structure is formed by the close contact between all the outer circumferential surfaces of the individual cover portions 30 separated from each other of the cables 21 to 24 and the back housing 371. These two liquid stopping structures can reliably prevent a liquid from entering the connector part 362 from the back end of the back housing 371 through the inside of the back housing 371. For example, even if a liquid may enter between the cover portions 30 due to a capillary phenomenon (even if the liquid passes through the first stopping structure), the liquid will not reach the connector part 362 because the second liquid stopping structure will surely prevent the liquid from flowing in the back housing 371 toward the connector part 362.

The connector device 361 according to the third embodiment can be manufactured by the same method as the connector device 301 according to the second embodiment. Further, in the connector device 361 according to the third embodiment, as in the connector device 301 according to the second embodiment, the resin injected into the mold when the back housing 371 is molded can be prevented from flowing out of the mold through between the cover portions 30 of the cables 21 to 24, and the molding failure of the back housing 371 can be suppressed.

The connector device 361 according to the third embodiment of the present invention having the above-described configuration exhibits the same or similar effect as the connector device 301 according to the second embodiment of the present invention. Further, in the connector device 361 according to the third embodiment of the present invention, the cable position regulating part 365 is provided on the intermediate cover member 364, that is, the cable position regulating member is coupled to the intermediate cover member 364. Thus, the size of the connector device in the front-and-back direction can be reduced, the number of members of the connector device can be reduced, and the manufacturing (assembly) of the connector device can be simplified.

(Fourth Embodiment) Next, as a fourth embodiment of the present invention, a method of manufacturing the connector device exhibiting the same or similar effect as the connector device 301 according to the second embodiment or the connector device 361 according to the third embodiment without providing the cable position regulating member or the cable position regulating part to the connector device will be described. Here, as an example of the manufacturing method, a method of manufacturing the connector device exhibiting the same or similar effect as the connector device 301 of the second embodiment or the connector device 361 of the third embodiment will be described using the members constituting the connector device 1 of the first embodiment.

In manufacturing the connector device, first, the members for forming the connector part 2, and the four cables 21 to 24 are prepared. The members for forming the connector part 2 are the body part 3, the upper cover member 6, the intermediate cover member 7, the lower cover member 8, and the connector housing 9 (see FIG. 5). Further, a mold for molding the back housing of the connector device is prepared.

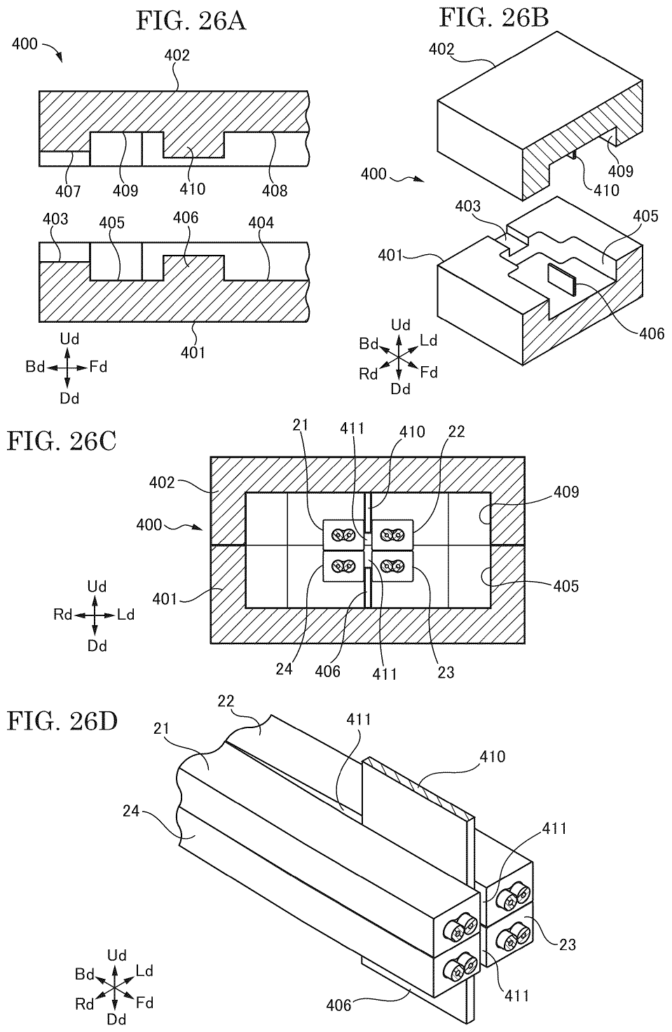

FIG. 26A shows a mold 400 for molding the back housing of the connector device according to the fourth embodiment of the present invention. FIG. 26A shows a state in which a first mold piece 401 and a second mold piece 402 of the mold 400 are cut into left and right along their center positions in the left-and-right direction, and the cross sections of the left portions of the cut first mold piece 401 and the cut second mold piece 402 are viewed from the right side. FIG. 26B shows a state in which the back portions of the first mold piece 401 and the second mold piece 402 are viewed from the upper right side.

As shown in FIGS. 26A and 26B, the mold 400 has the first mold piece 401 and the second mold piece 402. For example, the second mold piece 402 is movable upward and downward relative to the first mold piece 401.

The first mold piece 401 has a recess 403 (groove) for arranging the cable 23, the cable 24, the lower portion of the cable 21, and the lower portion of the cable 22. The first mold piece 401 has a recess 404 for arranging the lower portion of the connector part 2. The first mold piece 401 has a cavity 405 for filling the resin to form the back housing. The second mold piece 402 has a recess 407 (groove) for arranging the upper portions of the cables 21 and 22. The second mold piece 402 has a recess 408 for arranging the upper portion of the connector part 2. The second mold piece 402 has a cavity 409 for filling the resin to form the back housing. The above-described configuration of the first mold piece 401 and the second mold piece 402 is the same as that of the first mold piece 51 and the second mold piece 52 of the mold 50 in the first embodiment. The shape and size of the recess 403 of the first mold piece 401 and the recess 407 of the second mold piece 402 in the mold 400 are the same as the shape and size of the recess 53 of the first mold piece 51 and the recess 56 of the second mold piece 52 in the mold 50 of the first embodiment.

The first mold piece 401 and the second mode piece 402 of the fourth embodiment has cable position regulating pieces 406 and 410, respectively. The cable position regulating pieces 406 and 410 have a function of regulating the positions of respective cover portions 30 of the two cables adjacent to each other in the left-and-right direction in the cables 21 to 24 to form the spaced portions 411 between the respective cover portions 30 of the two cables. The cable position regulating piece 406 is formed in a plate shape extending in the front-and-back direction and the upper-and-lower direction, and protrudes upward from the center in the left-and-right direction of the front portion of the bottom surface of the cavity 405 in the first mold piece 401. The cable position regulating piece 410 is formed in a plate shape extending in the front-and-back direction and the upper-and-lower direction, and protrudes downward from the center in the left-and-right direction of the front portion of the ceiling surface of the cavity 409 in the second mold piece 402.

After the members for forming the connector part 2, the cables 21 to 24, and the mold 400 are prepared, the distal end portion of the front end portion of the cover portion 30 of each of the cables 21 to 24 is cut off to form the exposed portion 35 (an exposed portion formation step).

Next, while the body part 3, the upper cover member 6, the intermediate cover member 7, the lower cover member 8, and the connector housing 9 are assembled to form the connector part 2, the cables 21 to 24 are attached to the connector part 2 (a cable attachment step).

Next, the connector part 2 and the cables 21 to 24 are arranged in the mold 400, and the front end portions of the cables 21 to 24 are arranged (a cable arrangement step). For example, first, the lower portion of the connector part 2 is inserted into the recess 404 of the first mold piece 401, and the cables 23 and 24 are inserted into the recess 403 of the first mold piece 401 while the upper end portion of the cable position regulating piece 406 is inserted between the cover portion 30 of the cable 23 and the cover portion 30 of the cable 24, and the lower portion of the cable 21 and the lower portion of the cable 22 are inserted into the recess 403 of the first mold piece 401. Next, when the second mold piece 402 is attached to the first mold piece 401, the upper portion of the connector part 2 is inserted into the recess 408 of the second mold piece 402, and the upper portion of the cable 21 and the upper portion of the cable 22 are inserted into the recess 407 of the second mold piece 402 while the lower end portion of the cable position regulating piece 410 is inserted between the cover portion 30 of the cable 21 and the cover portion 30 of the cable 22.

In the state where the connector part 2 and the cables 21 to 24 are thus arranged in the mold 400, the front portions of the portions to be surrounded by the back housing in the front end portions of the cables 21 to 24 are arranged in the front portions of the cavities 405 and 409 of the mold 400. FIG. 26C shows the back portion of the mold 400 in which the cables 21 to 24 are arranged, as viewed from the front side. FIG. 26D shows a state where the cable position regulating pieces 406 and 410 provided in the mold 400 are inserted between the cover portions 30 of the cables 21 to 24. As shown in FIGS. 26C and 26D, in the state where the connector part 2 and the cables 21 to 24 are arranged in the mold 400, in the front portions of the portions to be surrounded by the back housing in the front end portions of the cables 21 to 24, the upper end portion of the cable position regulating piece 406 is inserted between the cover portion 30 of the cable 23 and the cover portion 30 of the cable 24, and the lower end portion of the cable position regulating piece 410 is inserted between the cover portion 30 of the cable 21 and the cover portion 30 of the cable 22. In this state, the upper end portion of the cable position regulating piece 406 and the lower end portion of the cable position regulating piece 410 are separated from each other. Thus, in the front portions of the portions to be surrounded by the back housing in the front end portions of the cables 21 to 24, the spaced portions 411 are formed between the cover portion 30 of the cable 23 and the cover portion 30 of the cable 24, and between the cover portion 30 of the cable 21 and the cover portion 30 of the cable 22.

In the state where the connector part 2 and the cables 21 to 24 are arranged in the mold 400, the back portions of the portions to be surrounded by the back housing in the front end portions of the cables 21 to 24 are arranged in the back portions of the cavities 405 and 409 of the mold 400. In the cables 21 to 24, the portions immediately behind the portions to be surrounded by the back housing are arranged between the recess 403 and the recess 407 of the mold 400. By arranging the portions immediately behind the portions to be surrounded by the back housing in the cables 21 to 24 between the recess 403 and the recess 407 of the mold 400, the portions immediately behind the portions to be surrounded by the back housing in the cables 21 to 24 are arranged such that the flat portions of the outer circumferences of the respective cover portions 30 of the two adjacent cables in the cables 21 to 24 are in contact with each other and there is no space formed by separating the respective cover portions 30 of the two adjacent cables in the cables 21 to 24 from each other within the cross section of the whole of the cables 21 to 24. Thereby, the back portions of the portions to be surrounded by the back housing in the cables 21 to 24 are displaced such that the respective cover portions 30 of the two adjacent cables in the cables 21 to 24 are brought into contact with each other, and the back portions of the portions to be surrounded by the back housing in the cables 21 to 24 are in the state where the spaced portions 411 are not present. As a result, the back portions of the portions to be surrounded by the back housing in the cables 21 to 24 are arranged such that the flat portions of the circumferences of the respective cover portions 30 of the two adjacent cables in the cables 21 to 24 are in contact with each other and there is no space formed by separating the respective cover portions 30 of the two adjacent cables in the cables 21 to 24 in the cross section of the whole of the cables 21 to 24.

Then, the molten resin is injected into the mold 400 to form the back housing (a housing formation step). Thus, the back end portion of the connector part 2 and the front end portions of the cables 21 to 24 are covered with the resin. Further, the resin enters the spaced portions 411 of the cables 21 to 24.

The back end portions of the cavities 405 and 409 of the mold 400 are closed by arranging the portions immediately behind the portions to be surrounded by the back housing in the front end portions of the cables 21 to 24 between the recess 403 of the first mold piece 401 and the recess 407 of the second mold piece 402. The front end portions of the cavities 405 and 409 of the mold 400 are closed by arranging the connector part 2 between the recess 404 of the first mold piece 401 and the recess 408 of the second mold piece 402. As a result, when the molten resin is injected into the cavities 405 and 409 of the mold 400, the resin does not flow out of the mold 400.

After the resin injected into the mold 400 is solidified, the connector device having the back housing is separated from the mold 400. This completes the connector device.

The connector device manufactured by the manufacturing method of the fourth embodiment has a configuration in which the back portions of the portions surrounded by the back housing in the front end portions of the cables 21 to 24 are arranged such that the flat portions of the outer circumferences of the respective cover portions 30 of the two adjacent cables in the cables 21 to 24 are in contact with each other and there is no space formed by separating the respective cover portions 30 of the two adjacent cables in the cables 21 to 24 within the cross section of the whole of the cables 21 to 24, while the front portions of the portions surrounded by the back housing in the front end portions of the cables 21 to 24 are arranged so as to form the spaced portion where the flat portions of the outer circumferences of the respective cover portions 30 of the two adjacent cables in the cables 21 to 24 face each other and are separated from each other.

In the connector device manufactured by the manufacturing method of the fourth embodiment, in the back housing, the resin for forming the back housing is in close contact with the right surface 34 and the upper surface 31 of the cover portion 30 of the cable 21, the left surface 33 and the upper surface 31 of the cover portion 30 of the cable 22, the left surface 33 and the lower surface 32 of the cover portion 30 of the cable 23, and the right surface 34 and the lower surface 32 of the cover portion 30 of the cable 24 with an extremely high degree of adhesion. In addition, in the connector device manufactured by the manufacturing method of the fourth embodiment, since the spaced portions 411 are formed in the cables 21 to 24, in the front portions of the portions surrounded by the back housing in the cables 21 to 24, the left surface 33 of the cover portion 30 of the cable 21 and the right surface 34 of the cover portion 30 of the cable 22 are separated from each other, and the left surface 33 of the cover portion 30 of the cable 23 and the right surface 34 of the cover portion 30 of the cable 24 are separated from each other, and the resin for forming the back housing enters the spaced portions 411, so that the resin is in close contact with the left surface 33 of the cover portion 30 of the cable 21, the right surface 34 of the cover portion 30 of the cable 22, the left surface 33 of the cover portion 30 of the cable 23, and the right surface 34 of the cover portion 30 of the cable 24 with an extremely high degree of adhesion. Therefore, according to the connector device manufactured by the manufacturing method of the fourth embodiment, the liquid stopping performance can be enhanced and the cable holding strength can be enhanced in the same manner as the connector device 301 of the second embodiment or the connector device 361 of the third embodiment.

In addition, according to the connector device manufactured by the manufacturing method of the fourth embodiment, as in the connector device 301 of the second embodiment and the connector device 361 of the third embodiment, the resin injected into the mold when the back housing is molded can be prevented from flowing out of the mold through between the cover portions 30 of the cables 21 to 24, and the molding failure of the back housing can be suppressed.

As described above, according to the method of manufacturing the connector device according to the fourth embodiment of the present invention, it is possible to manufacture the connector device exhibiting the same or similar effect as the connector device 301 according to the second embodiment or the connector device 361 according to the third embodiment without providing the cable position regulating member or the cable position regulating part in the connector device.

In the above-described embodiments, the case in which the two-core shield cable as shown in FIG. 6A is used as each of the cables 21 to 24 is taken as an example, but the type of cable is not limited in the connector device of the present invention. In the connector device of the present invention, the configuration of the core portion of the cable is not limited. In the connector device of the present invention, a plurality of cables having different core portions may be used.

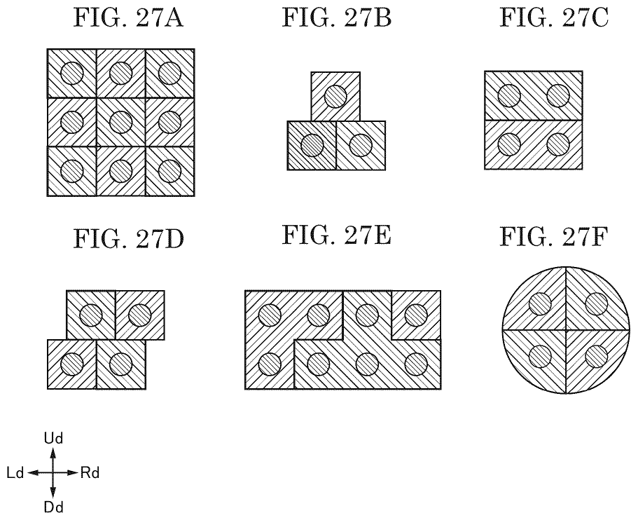

Further, although the connector device 1 (301, 361) of the above-described embodiments includes the four cables 21 to 24, the number of cables may be two, three, or five or more in the connector device of the present invention. In the embodiments, the cross-sectional shape of the cover portion 30 of each of the cables 21 to 24 is quadrilateral, and the cables 21 to 24 are arranged in two rows in the upper-and-lower direction and in two rows in the left-and-right direction, but in the connector device of the present invention, the cross-sectional shape of the cover portion of each cable and the arrangement of the plurality of cables are not limited. FIGS. 27A to 27F show some other examples of the cross-sectional shape of the cover portion and the arrangement of the plurality of cables that may be employed by the connector device of the present invention. FIG. 27A shows an example in which nine cables each having the cover portion of a quadrilateral cross section are arranged in three rows in the upper-and-lower direction and in three rows in the left-and-right direction. FIG. 27B shows an example in which three cables each having the cover portion of a quadrilateral cross section are arranged in two rows in the upper-and-lower direction, in which the upper row includes one cable and the lower row includes two cables. FIG. 27C shows an example in which two parallel two-wire cables each having the cover portion of a quadrilateral cross section are arranged in two rows in the upper-and-lower direction. FIG. 27D shows an example in which four cables each having the cover portion of a quadrilateral cross section are arranged in two rows in the upper-and-lower direction and in two rows in the left-and-right direction, and the positions of the two upper cables and the two lower cables do not match in the left-and-right direction. FIG. 27E shows an example in which three cables having the cover portions of different polygonal cross sections are arranged such that the flat portions of the circumferences of the adjacent cover portions are in contact with each other. FIG. 27F shows an example in which four cables each having the fan-shaped cover portion are arranged such that the flat portions of the outer circumferences of the adjacent cover portions are in contact with each other, and the outer profile of the cross section of the whole of the four cables is circular. In each of FIGS. 27A to 27F, the plurality of cables are arranged such that there is no space formed by wholly or partially separating the respective cover portions of the two adjacent cables in the cables within the cross section of the whole of the cables. Furthermore, the arrangements of the plurality of cables shown in FIGS. 27A to 27F are suitable for reducing the mold cost. That is, according to the arrangements of the plurality of cables shown in FIGS. 27A to 27F, it is possible to prevent the formation of a space through which the molten resin can pass between the plurality of cables and the mold without using an insert in the mold when molding the back housing.

Further, in the cable position regulating member 302 according to the second embodiment, notches may be provided on the surface of the insertion plate portions 303 to 305, and when the back housing 315 is molded, the resin injected into the mold 320 may flow into the notches and into the spaced portions 313 of the cables 21 to 24. Thus, the resin can be smoothly flowed into the spaced portions 313, and the resin and the cover portion 30 can be surely brought into close contact with each other. Such a structure may be provided in the cable position regulating part 365 of the third embodiment or the cable position regulating pieces 406 and 410 of the fourth embodiment.

In the connector device according to the present invention, the flat portions may be formed only on the outer circumference of the front end portion of the cover portion of each cable.

Further, in the connector device of the present invention, the range of forming the housing (back housing) may be any range including a portion from the other end (back end) of the connection part to one end (front end) of the respective cover portions of the plurality of cables, and for example, in a case where the shape of the fitting part of one end of the connection part is female, the outer circumference of the portion from one end of the connection part to one ends of the respective cover portions of the plurality of cables may be covered with the housing.

The connecting object to which the connector device of the present invention can be connected is not limited to the receptacle as shown in FIG. 1, but may be, for example, a plug.

In the connector device 1 according to the first embodiment, the front end portions of the cables 21 to 24 are arranged in parallel such that the flat portions of the respective cover portions 30 of the two adjacent cables in the cables 21 to 24 are in contact with each other and there is no space formed by separating the respective cover portions 30 of the two adjacent cables in the cables 21 to 24 within the cross section of the whole of the cables 21 to 24. In the first embodiment, the “space” means a space having a size enough to allow the molten resin to flow out of the mold when the back housing 41 is molded, and a space having a size enough to allow a liquid to enter from the back end of the back housing 41 in the inside of the back housing 41. However, in the present invention, the “space” may mean only a space having a size enough to allow the molten resin to flow out of the mold. For example, the “space” may mean a space formed such that a small amount of the molten resin may flow into the space, and the molten resin may be cooled after flowing into the space and its viscosity is increased due to the small amount so that it does not flow out of the mold. That is, in the front end portions of the cables 21 to 24, it may not be allowable to form a space having a size enough for the molten resin to flow out of the mold by separating the respective cover portions 30 of the two adjacent cables in the cables 21 to 24 from each other within the cross section of the whole of the cables 21 to 24, but it may be allowable to form a space having a size enough for a liquid to enter from the back end of the back housing 41 in the inside of the back housing 41 by a capillary phenomenon. In this case, a liquid (for example, water) may enter between the cover portions 30 facing each other at the front end portions of the cables 21 to 24 due to a capillary phenomenon. However, the flowing of the liquid in the back housing 41 toward the connector part 2 is surely prevented by the liquid stopping structure by close contact between the exposed portion 35 of the core portion 25 of each of the cables 21 to 24 and the back housing 41, so that the liquid does not reach the connector part 2.

Further, the back portions of the portions surrounded by the back housing 315 in the cables 21 to 24 of the connector device 301 of the second embodiment are arranged in parallel such that the flat portions of the respective cover portions 30 of the two adjacent cables in the cables 21 to 24 are in contact with each other and there is no space formed by separating the respective cover portions 30 of the two adjacent cables in the cables 21 to 24 within the cross section of the whole of the cables 21 to 24. In the second embodiment, the “space” means a space having a size enough to allow the molten resin to flow out of the mold when the back housing 315 is molded, and a space having a size enough to allow a liquid to enter from the back end of the back housing 315 in the inside of the back housing 315. However, in the present invention, the “space” may mean only a space having a size enough for the molten resin to flow out of the mold. That is, in the back portions of the portions surrounded by the back housing 315 in the cables 21 to 24, it may not be allowable to form a space having a size enough for the molten resin to flow out of the mold by separating the respective cover portions 30 of the two adjacent cables in the cables 21 to 24 within the cross section of the whole of the cables 21 to 24, but it may be allowable to form a space having a size enough for a liquid to enter from the back end of the back housing 41 in the inside of the back housing 41 by a capillary phenomenon. In this case, a liquid (for example, a water) may enter between the cover portions 30 facing each other in the front end portions of the cables 21 to 24 by a capillary phenomenon, but the liquid does not reach the connector part 2 because the flowing of the liquid in the back housing 315 toward the connection part 2 is surely prevented at the front portions of the portions surrounded by the back housing 315 in the cables 21 to 24 by the liquid stopping structure formed by the close contact between all the outer circumferences of the individual cover portions 30 separated from each other of the cables 21 to 24 and the back housing 315. This point also applies to the connector device 361 of the third embodiment and the connector device manufactured by the manufacturing method of the fourth embodiment.

In addition, the present invention may be modified as appropriate to the extent that it is not contrary to the spirit or idea of the invention, which can be read from the claims and the description as a whole, and the connector device and the method of manufacturing the same with such modification are also included in the technical philosophy of the present invention.

1. A connector device comprising:
a connection part whose one end portion is connected to a connecting object;
a plurality of cables extending from the other end portion of the connection part; and
a housing, wherein
each of the plurality of cables has a core portion and a cover portion covering an outer circumference of the core portion,
a flat portion is formed on an outer circumferential surface of the cover portion of each of the plurality of cables,
one end portions of the plurality of cables are arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and
the housing surrounds a portion from the other end portion of the connection part to one end portions of the respective cover portions of the plurality of cables, and is integrated with the portion by overmolding.

2. The connector device according to claim 1, wherein
exposed portions exposed from the cover portions are formed at one end portions of the respective core portions of the plurality of cables,
the other end portions of the exposed portions of the respective core portions of the plurality of cables are exposed from the other end portion of the connection part to an outside of the connection part, and
the housing surrounds the other end portion of the connection part, the other end portions of the exposed portions of the respective core portions of the plurality of cables, and one end portions of the respective cover portions of the plurality of cables, and is integrated with the other end portion of the connection part, the other end portions of the exposed portions of the respective core portions of the plurality of cables, and one end portions of the respective cover portions of the plurality of cables by overmolding.

3. The connector device according to claim 1, wherein
the plurality of cables includes four or more cables,
when an extension direction of the plurality of cables is defined as a front-and-back direction, the plurality of cables are arranged in two or more rows in an upper-and-lower direction and in two or more rows in a left-and-right direction.

4. The connector device according to claim 1, wherein
the plurality of cables includes a first cable, a second cable, a third cable, and a fourth cable,
when an extension direction of the first cable is defined as a front-and-back direction, a flat portion is formed on a left portion and a lower portion of the outer circumferential surface of the cover portion of the first cable, respectively,
when an extension direction of the second cable is defined as the front-and-back direction, a flat portion is formed on a right portion and a lower portion of the outer circumferential surface of the cover portion of the second cable, respectively,
when an extension direction of the third cable is defined as the front-and-back direction, a flat portion is formed on a right portion and an upper portion of the outer circumferential surface of the cover portion of the third cable, respectively,
when an extension direction of the fourth cable is defined as the front-and-back direction, a flat portion is formed on a left portion and an upper portion of the outer circumferential surface of the cover portion of the fourth cable, respectively, and
the first cable, the second cable, the third cable, and the fourth cable are arranged such that the flat portion of the left portion of the cover portion of the first cable and the flat portion of the right portion of the cover portion of the second cable are in contact with each other, the flat portion of the lower portion of the cover portion of the second cable and the flat portion of the upper portion of the cover portion of the third cable are in contact with each other, the flat portion of the right portion of the cover portion of the third cable and the flat portion of the left portion of the cover portion of the fourth cable are in contact with each other, and the flat portion of the upper portion of the cover portion of the fourth cable and the flat portion of the lower portion of the cover portion of the first cable are in contact with each other.

5. The connector device according to claim 1, wherein
the plurality of cables includes a first cable, a second cable, a third cable, and a fourth cable,
an outer profile of a cross section of the cover portion of each of the first cable, the second cable, the third cable and the fourth cable is quadrilateral,
when an extension direction of each of the first cable, the second cable, the third cable, and the fourth cable is defined as a front-and-back direction, the first cable, the second cable, the third cable, and the fourth cable are arranged such that a left surface of the cover portion of the first cable and the a right surface of the cover portion of the second cable are in contact with each other, a lower surface of the cover portion of the second cable and an upper surface of the cover portion of the third cable are in contact with each other, a right surface of the cover portion of the third cable and a left surface of the cover portion of the fourth cable are in contact with each other, and an upper surface of the cover portion of the fourth cable and a lower surface of the cover portion of the first cable are in contact with each other.

6. The connector device according to claim 1, wherein
an outer profile of a cross section of the cover portion of each of the plurality of cables is a quadrilateral having four internal angles of 90 degrees.

7. The connector device according to claim 6, wherein
one end portions of the plurality of cables are arranged such that an outer profile of a cross section of a whole of the plurality of cables is a quadrilateral having four internal angles of 90 degrees.

8. The connector device according to claim 1, wherein
the plurality of cables extend backwardly from a back end portion of the connection part, and the housing is a resin molded product which surrounds a portion from the back end portion of the connection part to front end portions of the respective cover portions of the plurality of cables and is integrated with the portion by overmolding,
back portions of portions surrounded by the housing in the plurality of cables are arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and
front portions of the portions surrounded by the housing in the plurality of cables are arranged in parallel so as to form a spaced portion where the respective cover portions of the two adjacent cables in the plurality of cables are separated from each other.

9. The connector device according to claim 8, wherein
the plurality of cables includes four or more cables,
the plurality of cables are arranged in two or more rows in an upper-and-lower direction and in two or more rows in a left-and-right direction,
the back portions of the portions surrounded by the housing in the plurality of cables are arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and
the front portions of the portions surrounded by the housing in the plurality of cables are arranged so as to form a spaced portion where the respective cover portions of the two cables adjacent to each other in the upper-and-lower direction in the plurality of cables are separated from each other, or to form a spaced portion where the respective cover portions of the two cables adjacent to each other in the left-and-right direction in the plurality of cables are separated from each other.

10. The connector device according to claim 8, wherein
the plurality of cables includes a first cable, a second cable, a third cable, and a fourth cable,
a flat portion is formed on a left portion and a lower portion of the outer circumferential surface of the cover portion of the first cable, respectively,
a flat portion is formed on a right portion and a lower portion of the outer circumferential surface of the cover portion of the second cable, respectively,
a flat portion is formed on a right portion and an upper portion of the outer circumferential surface of the cover portion of the third cable, respectively,
a flat portion is formed on a left portion and an upper portion of the outer circumferential surface of the cover portion of the fourth cable, respectively, wherein
the back portions of the portions surrounded by the housing in the first cable, the second cable, the third cable, and the fourth cable are arranged such that the flat portion of the left portion of the cover portion of the first cable and the flat portion of the right portion of the cover portion of the second cable are in contact with each other, the flat portion of the lower portion of the cover portion of the second cable and the flat portion of the upper portion of the cover portion of the third cable are in contact with each other, the flat portion of the right portion of the cover portion of the third cable and the flat portion of the left portion of the cover portion of the fourth cable are in contact with each other, and the flat portion of the upper portion of the cover portion of the fourth cable and the flat portion of the lower portion of the cover portion of the first cable are in contact with each other, and
the front portions of the portions surrounded by the housing in the first cable, the second cable, the third cable, and the fourth cable are arranged such that the flat portion of the left portion of the cover portion of the first cable and the flat portion of the right portion of the cover portion of the second cable are separated from each other, the flat portion of the lower portion of the cover portion of the second cable and the flat portion of the upper portion of the cover portion of the third cable are separated from each other, the flat portion of the right portion of the cover portion of the third cable and the flat portion of the left portion of the cover portion of the fourth cable are separated from each other, or the flat portion of the upper portion of the cover portion of the fourth cable and the flat portion of the lower portion of the cover portion of the first cable are separated from each other.

11. The connector device according to claim 8, wherein
the plurality of cables includes a first cable, a second cable, a third cable, and a fourth cable,
an outer profile of a cross section of the cover portion of each of the first cable, the second cable, the third cable and the fourth cable is quadrilateral, wherein
the back portions of the portions surrounded by the housing in the first cable, the second cable, the third cable, and the fourth cable are arranged such that the left surface of the cover portion of the first cable and the right surface of the cover portion of the second cable are in contact with each other, the lower surface of the cover portion of the second cable and the upper surface of the cover portion of the third cable are in contact with each other, the right surface of the cover portion of the third cable and the left surface of the cover portion of the fourth cable are in contact with each other, and the upper surface of the cover portion of the fourth cable and the lower surface of the cover portion of the first cable are in contact with each other, and
the front portions of the portions surrounded by the housing in the first cable, the second cable, the third cable, and the fourth cable are arranged such that the left surface of the cover portion of the first cable and the right surface of the cover portion of the second cable are separated from each other, the lower portion of the cover portion of the second cable and the upper surface of the cover portion of the third cable are separated from each other, the right surface of the cover portion of the third cable and the left surface of the cover portion of the fourth cable are separated from each other, or the upper surface of the cover portion of the fourth cable and the lower surface of the cover portion of the first cable are separated from each other.

12. The connector device according to claim 8, comprising:
a cable position regulating member for regulating positions of the respective cover portions of the two adjacent cables in the plurality of cables to form the spaced portion between the respective cover portions of the two cables.

13. The connector device according to claim 12, wherein
the cable position regulating member is coupled to the connection part.

14. A method of manufacturing a connector device, the connector device including a connection part whose one end portion is connected to a connecting object, a plurality of cables extending from the other end portion of the connection part, and a housing, wherein each of the plurality of cables has a core portion and a cover portion covering an outer circumference of the core portion, a flat portion is formed on an outer circumferential surface of the cover portion of each of the plurality of cables, one end portions of the plurality of cables are arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and the housing surrounds a portion from the other end portion of the connection part to one end portions of the respective cover portions of the plurality of cables, and is integrated with the portion, the method comprising:
a cable attachment step of attaching the plurality of cables to the connection part such that the plurality of cables extend from the other end portion of the connection part;
a cable arrangement step of arranging one end portions of the plurality of cables in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables; and
a housing formation step of forming the housing by overmolding on an outer circumference of the portion from the other end portion of the connection part to one end portions of the respective cover portions of the plurality of cables.

15. The method of manufacturing the connector device according to claim 14, wherein
the plurality of cables extend backwardly from a back end portion of the connection part, and the housing is a resin molded product which surrounds a portion from a back end portion of the connection part to front end portions of the respective cover portions of the plurality of cables and is integrated with the portion by overmolding,
back portions of portions surrounded by the housing in the plurality of cables are arranged in parallel such that the flat portions of the respective cover portions of the two adjacent cables in the plurality of cables are in contact with each other and there is no space formed by separating the respective cover portions of the two adjacent cables in the plurality of cables within a cross section of a whole of the plurality of cables, and
front portions of the portions surrounded by the housing in the plurality of cables are arranged in parallel so as to form a spaced portion where the respective cover portions of the two adjacent cables in the plurality of cables are separated from each other, wherein
in the cable attachment step, the plurality of cables are attached to the connection part such that the plurality of cables extend backward from the back end portion of the connection part;
in the cable arrangement step, the back portions of the portions surrounded by the housing in the plurality of cables are arranged in a mold such that the flat portions of the respective cover portions of the two adjacent cables in the plurality of cables are in contact with each other and there is no space formed by separating the respective cover portions of the two adjacent cables in the plurality of cables within the cross section of the whole of the plurality of cables, and the front portions of the portions surrounded by the housing in the plurality of cables are arranged in the mold such that the spaced portion is formed,
in the housing formation step, resin is injected into the mold to form the housing by overmolding on the outer circumference of the portion from the back end portion of the connection part to the front end portions of the respective cover portions of the plurality of cables,
a cable position regulating piece is put or formed in the mold, the cable position regulating piece regulates positions of the respective cover portions of the two adjacent cables in the plurality of cables to form the spaced portion between the respective cover portions of the two cables, and when the plurality of cables are arranged in the mold in the cable arrangement step, the cable position regulating piece is inserted between the respective cover portions of the two adjacent cables in the plurality of cables to form the spaced portion between the respective cover portions of the two cables.

16. The connector device according to claim 2, wherein
the plurality of cables includes four or more cables,
when an extension direction of the plurality of cables is defined as a front-and-back direction, the plurality of cables are arranged in two or more rows in an upper-and-lower direction and in two or more rows in a left-and-right direction.

17. The connector device according to claim 2, wherein
the plurality of cables includes a first cable, a second cable, a third cable, and a fourth cable,
when an extension direction of the first cable is defined as a front-and-back direction, a flat portion is formed on a left portion and a lower portion of the outer circumferential surface of the cover portion of the first cable, respectively,
when an extension direction of the second cable is defined as the front-and-back direction, a flat portion is formed on a right portion and a lower portion of the outer circumferential surface of the cover portion of the second cable, respectively,
when an extension direction of the third cable is defined as the front-and-back direction, a flat portion is formed on a right portion and an upper portion of the outer circumferential surface of the cover portion of the third cable, respectively,
when an extension direction of the fourth cable is defined as the front-and-back direction, a flat portion is formed on a left portion and an upper portion of the outer circumferential surface of the cover portion of the fourth cable, respectively, and
the first cable, the second cable, the third cable, and the fourth cable are arranged such that the flat portion of the left portion of the cover portion of the first cable and the flat portion of the right portion of the cover portion of the second cable are in contact with each other, the flat portion of the lower portion of the cover portion of the second cable and the flat portion of the upper portion of the cover portion of the third cable are in contact with each other, the flat portion of the right portion of the cover portion of the third cable and the flat portion of the left portion of the cover portion of the fourth cable are in contact with each other, and the flat portion of the upper portion of the cover portion of the fourth cable and the flat portion of the lower portion of the cover portion of the first cable are in contact with each other.

18. The connector device according to claim 2, wherein
the plurality of cables includes a first cable, a second cable, a third cable, and a fourth cable,
an outer profile of a cross section of the cover portion of each of the first cable, the second cable, the third cable and the fourth cable is quadrilateral,
when an extension direction of each of the first cable, the second cable, the third cable, and the fourth cable is defined as a front-and-back direction, the first cable, the second cable, the third cable, and the fourth cable are arranged such that a left surface of the cover portion of the first cable and the a right surface of the cover portion of the second cable are in contact with each other, a lower surface of the cover portion of the second cable and an upper surface of the cover portion of the third cable are in contact with each other, a right surface of the cover portion of the third cable and a left surface of the cover portion of the fourth cable are in contact with each other, and an upper surface of the cover portion of the fourth cable and a lower surface of the cover portion of the first cable are in contact with each other.

19. The connector device according to claim 2, wherein
an outer profile of a cross section of the cover portion of each of the plurality of cables is a quadrilateral having four internal angles of 90 degrees.
